(19) United States
(12) Patent Application Publication
(10) Pub. No.: US 2022/0415178 A1
(43) Pub. Date: Dec. 29, 2022

(54) MOVEMENT ASSISTANCE DEVICE, MOVEMENT ASSISTANCE LEARNING DEVICE, AND MOVEMENT ASSISTANCE METHOD

(71) Applicant: Mitsubishi Electric Corporation, Tokyo (JP)

(72) Inventor: Hiroyoshi SHIBATA, Tokyo (JP)

(73) Assignee: Mitsubishi Electric Corporation, Tokyo (JP)

(21) Appl. No.: 17/781,234

(22) PCT Filed: Jan. 20, 2020
(86) PCT No.: PCT/JP2020/001641

§ 371 Date: May 31, 2022

(51) Int. Cl. G08G 1/16; G01S 13/931; G01S 17/931

(52) U.S. Cl. CPC G08G 1/167; G01S 13/931; G01S 17/931; G06V 20/58

(57) ABSTRACT

A movement assistance device includes a blind spot object acquiring unit to acquire blind spot object information indicating a position or a type of each of one or more objects present in a blind spot area of a mobile object sensor provided on a mobile object; a contact object specifying unit to specify an object with which the mobile object might come into contact when the mobile object moves out of the one or more objects present in the blind spot area on the basis of the blind spot object information; and a movement assistance information acquiring unit to input the blind spot object information corresponding to the object specified by the contact object specifying unit to a learned model and acquires movement assistance information, which is information output by the learned model as an inference result, the information for avoiding contact of the mobile object with the object.

### TECHNICAL FIELD

The present invention relates to a movement assistance device, a movement assistance learning device, and a movement assistance method.

### BACKGROUND ART

There is a technology of performing driving assistance in consideration of a condition of an area in a blind spot while a vehicle is traveling.

For example, Patent Literature 1 discloses a driving assistance device that performs driving assistance on the basis of a degree of danger of a blind spot area output by a danger degree calculating device provided with a traffic environment information acquiring unit to acquire traffic environment information in vehicle travel, a blind spot area detecting unit to detect a blind spot area formed by an obstacle, a dynamic information extracting unit to extract dynamic information contributing to a degree of danger of the blind spot area from the traffic environment information acquired by the traffic environment acquiring unit, and a danger degree calculating unit to set the danger of degree of the blind spot area on the basis of the dynamic information contributing to the detected degree of danger of the blind spot area.

A conventional driving assistance device (hereinafter, referred to as a “conventional driving assistance device”) disclosed in Patent Literature 1 performs the driving assistance on the basis of the degree of danger obtained by integrating a probability that a mobile object runss out of the blind spot area depending on a condition of the blind spot area.

### CITATION LIST

### Patent Literatures

Patent Literature 1: JP 2012-104029 A

### SUMMARY OF INVENTION

### Technical Problem

However, since the conventional driving assistance device performs driving assistance on the basis only of a degree of danger obtained by integration, there has been a problem that only driving assistance such as simple warning based on the degree of danger or simple driving control such as speed control based on the degree of danger can be performed, and advanced driving assistance such as a change in traveling direction cannot be performed.

The present invention is for solving the above-described problem, and an object thereof is to provide a movement assistance device capable of performing, in consideration of a condition of an area in a blind spot as seen from a moving mobile object including a traveling vehicle, advanced movement assistance on the mobile object.

### Solution to Problem

A movement assistance device according to the present invention includes a mobile object sensor information acquiring unit to acquire mobile object sensor information output by a mobile object sensor provided on a mobile object, a blind spot area acquiring unit to acquire blind spot area information indicating a blind spot area of the mobile object sensor on the basis of the mobile object sensor information acquired by the mobile object sensor information acquiring unit, a blind spot object acquiring unit to acquire blind spot object information indicating a position or a type of each of one or more objects present in the blind spot area indicated by the blind spot area information acquired by the blind spot area acquiring unit, a contact object specifying unit to specify the object with which the mobile object might come into contact when the mobile object moves out of the one or more objects present in the blind spot area on the basis of the blind spot object information acquired by the blind spot object acquiring unit, a movement assistance information acquiring unit to input the blind spot object information corresponding to the object specified by the contact object specifying unit to a learned model and acquire movement assistance information, which is information output by the learned model as an inference result, the information for avoiding contact of the mobile object with the object, and a movement assistance information outputting unit to output the movement assistance information acquired by the movement assistance information acquiring unit.

### Advantageous Effects of Invention

According to the present invention, it is possible to perform, in consideration of a condition of an area in a blind spot as seen from the moving mobile object including a traveling vehicle, advanced movement assistance to the mobile object.

### BRIEF DESCRIPTION OF DRAWINGS

FIG. 1 is a block diagram illustrating an example of a configuration of a substantial part of a movement assistance system according to a first embodiment.

FIG. 2 is a block diagram illustrating an example of a configuration of a substantial part of a movement assistance device according to the first embodiment.

FIG. 3 is a diagram illustrating an example of a degree of danger determined in advance for each type of a blind spot object according to the first embodiment.

FIGS. 4A and 4B are diagrams illustrating an example of a substantial part of a hardware configuration of the movement assistance device according to the first embodiment.

FIG. 5 is a flowchart illustrating an example of processing of the movement assistance device according to the first embodiment.

FIG. 6 is a block diagram illustrating an example of a substantial part of a movement assistance learning system according to the first embodiment.

FIG. 7 is a block diagram illustrating an example of a configuration of a substantial part of a movement assistance learning device according to the first embodiment.

FIG. 8 is a flowchart illustrating an example of processing of the movement assistance learning device according to the first embodiment.

FIG. 9 is a block diagram illustrating an example of a substantial part of a movement assistance system according to a second embodiment.

FIG. 10 is a block diagram illustrating an example of a configuration of a substantial part of a movement assistance device according to the second embodiment.

FIG. 11 is a flowchart illustrating an example of processing of the movement assistance device according to the second embodiment.

FIG. 12 is a block diagram illustrating an example of a substantial part of a movement assistance learning system according to the second embodiment.

FIG. 13 is a block diagram illustrating an example of a configuration of a substantial part of a movement assistance learning device according to the second embodiment.

FIG. 14 is a flowchart illustrating an example of processing of the movement assistance learning device according to the second embodiment.

### DESCRIPTION OF EMBODIMENTS

Hereinafter, embodiments of the present invention are described in detail with reference to the drawings.

### First Embodiment

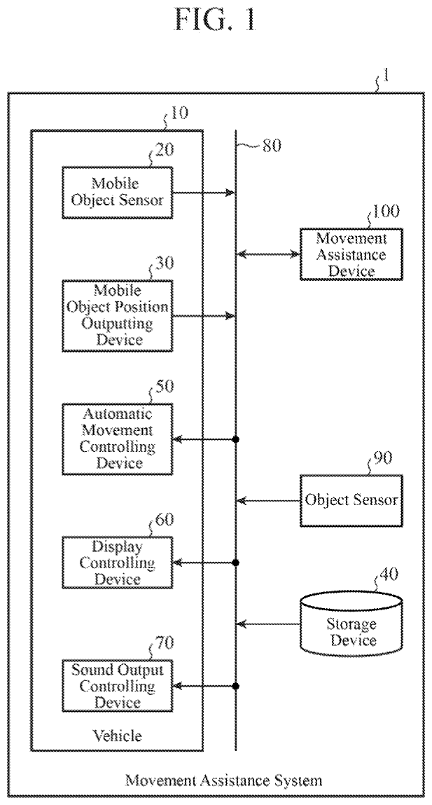

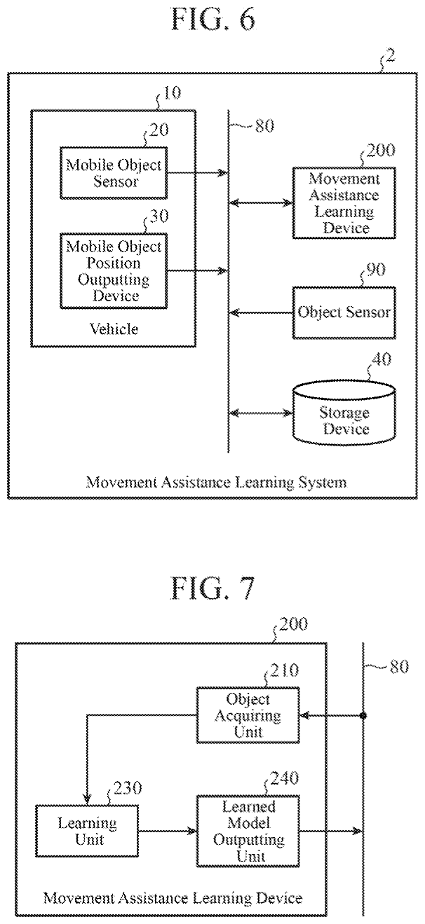

A movement assistance device 100 according to a first embodiment is described with reference to FIGS. 1 to 5. A movement assistance learning device 200 according to the first embodiment is described with reference to FIGS. 6 to 8.

As an example, the movement assistance device 100 and the movement assistance learning device 200 according to the first embodiment are applied to a vehicle 10 as a mobile object.

In the first embodiment, the mobile object is described as the vehicle 10, but the mobile object is not limited to the vehicle 10. For example, the mobile object may be a pedestrian, a bicycle, a motorcycle, a mobile robot or the like.

A configuration of a substantial part of a movement assistance system 1 to which the movement assistance device 100 according to the first embodiment is applied is described with reference to FIG. 1.

FIG. 1 is a block diagram illustrating an example of the configuration of the substantial part of the movement assistance system 1 to which the movement assistance device 100 according to the first embodiment is applied.

The movement assistance system 1 according to the first embodiment is provided with the movement assistance device 100, the vehicle 10, a mobile object sensor 20, a mobile object position outputting device 30, a storage device 40, an automatic movement controlling device 50, a display controlling device 60, a sound output controlling device 70, a network 80, and an object sensor 90.

The vehicle 10 is the mobile object such as an automatic automobile equipped with an engine, a motor or the like.

The movement assistance device 100 acquires movement assistance information and outputs the movement assistance information. The movement assistance device 100 may be installed in the vehicle 10 or may be installed in a predetermined place outside the vehicle 10. In the first embodiment, it is described on the premise that the movement assistance device 100 is installed in the predetermined place outside the vehicle 10.

The movement assistance device 100 is described later in detail.

The mobile object sensor 20 is a sensor provided on the vehicle 10 as the mobile object. Specifically, for example, the mobile object sensor 20 is an imaging device such as a digital still camera, a digital video camera, an infrared camera, or a point group camera, or a ranging sensor such as a sonar, a millimeter wave radar, or a laser radar. The mobile object sensor 20 images or measures the outside of the vehicle 10. The mobile object sensor 20 outputs, as mobile object sensor information, image information indicating an image imaged by the mobile object sensor 20, a sensor signal indicating a result of measurement by the mobile object sensor 20 or the like.

In a case where the mobile object is the bicycle, the motorcycle, the mobile robot or the like, the mobile object sensor 20 is, for example, the imaging device or the ranging sensor provided on the mobile object. In a case where the mobile object is the pedestrian, the mobile object sensor 20 is, for example, the imaging device or the ranging sensor carried by the pedestrian as the mobile object, or the imaging device or the ranging sensor provided on an article such as glasses, clothes, a bag, or a cane carried by the pedestrian.

The mobile object position outputting device 30 outputs mobile object position information indicating a position of the vehicle 10 as the mobile object. The mobile object position outputting device 30 is installed in the vehicle 10, for example, and generates the mobile object position information indicating the position of the vehicle 10 by estimating the position of the vehicle 10 using a navigation system such as a global navigation satellite system (GNSS), and outputs the generated mobile object position information.

Note that, a method of estimating the position using the navigation system and the like is known, so that description thereof is omitted.

In a case where the mobile object is the bicycle, the motorcycle, the mobile robot or the like, the mobile object position outputting device 30 is installed on, for example, the mobile object. In a case where the mobile object is the pedestrian, the mobile object position outputting device 30 is implemented as one function of a mobile terminal such as a smartphone carried by the pedestrian as the mobile object, for example.

The storage device 40 is a device for the movement assistance device 100 to store necessary information. The storage device 40 is provided with a storage medium such as a solid state drive (SSD) or a hard disk drive (HDD) for storing the information. The storage device 40 inputs and outputs, in response to a read or write request from the outside of the device, information that meets the request.

The automatic movement controlling device 50 is installed in the vehicle 10, for example, and performs vehicle control such as steering control, brake control, accelerator control, or horn control on the vehicle 10 on the basis of the movement assistance information.

The movement assistance information is information indicating a steering control amount, information indicating a brake control amount, information indicating an accelerator control amount, information indicating the horn control or the like. The movement assistance information may be information indicating a position of the vehicle 10 in a road width direction of a road on which the vehicle 10 travels, information indicating a speed at which the vehicle 10 travels, information instructing the vehicle 10 to sound a horn or the like.

In a case where the mobile object is the bicycle, the motorcycle, the mobile robot or the like, the automatic movement controlling device 50 is installed on the mobile object, for example.

The display controlling device 60 is installed in the vehicle 10, for example, and generates a display image signal based on the movement assistance information. The display controlling device 60 outputs the display image signal generated by the display controlling device 60 to a display device not illustrated provided on the vehicle 10 and the like, thereby allowing the display device to display a display image indicated by the display image signal. The display image indicated by the display image signal displayed on the display device is, for example, an image for prompting a moving person of the vehicle 10 to operate a steering wheel, a brake, or an accelerator, an image for prompting the moving person to sound the horn or the like.

In a case where the mobile object is the bicycle, the motorcycle or the like, for example, the display controlling device 60 is installed on the mobile object. In a case where the mobile object is the pedestrian, for example, the display controlling device 60 is implemented as one function of the mobile terminal such as the smartphone carried by the pedestrian as the mobile object.

The sound output controlling device 70 is installed in the vehicle 10, for example, and generates a sound signal based on the movement assistance information. The sound output controlling device 70 outputs the sound signal generated by the sound output controlling device 70 to a sound outputting device not illustrated provided on the vehicle 10 and the like, thereby allowing the sound outputting device to output a sound indicated by the sound signal. The sound indicated by the sound signal output from the sound outputting device is, for example, a sound for prompting the moving person of the vehicle 10 to operate the steering wheel, the brake, or the accelerator, a sound for prompting the moving person to sound the horn or the like.

In a case where the mobile object is the bicycle, the motorcycle or the like, for example, the sound output controlling device 70 is installed on the mobile object. In a case where the mobile object is the pedestrian, for example, the sound output controlling device 70 is implemented as one function of the mobile terminal such as the smartphone carried by the pedestrian as the mobile object.

The network 80 is a wired or wireless information communication network. The movement assistance device 100 acquires information necessary for the movement assistance device 100 to operate via the network 80. The movement assistance device 100 outputs the movement assistance information acquired by the movement assistance device 100 to the automatic movement controlling device 50, the display controlling device 60, the sound output controlling device 70 or the like via the network 80.

The object sensor 90 is, for example, a sensor such as an imaging device or a ranging sensor. The object sensor 90 is installed, for example, on a vehicle other than the vehicle 10, a motorcycle or the like that travels on the road on which the vehicle 10 as the mobile object is traveling, or on a road in contact with the road or the like. The object sensor 90 is installed on, for example, a structure such as a traffic light installed on the road on which the vehicle 10 as the mobile object is traveling, or on the road in contact with the road or the like, or a structure such as a house, a fence, a building or the like present at a position adjacent to the road on which the vehicle 10 is traveling, or on the road in contact with the road or the like. The object sensor 90 images or measures an area including a blind spot area, which is an area in a blind spot of the mobile object sensor 20.

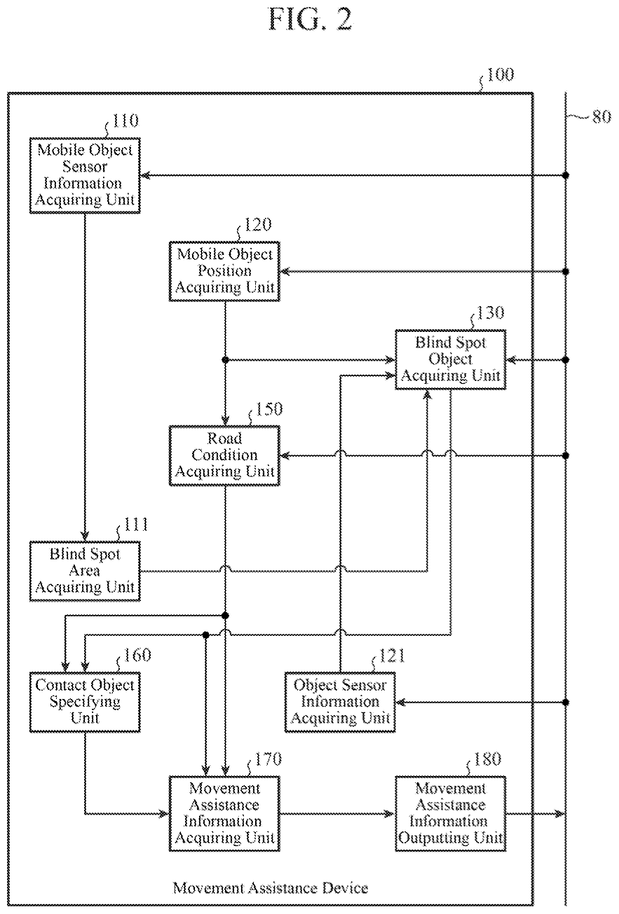

A configuration of a substantial part of the movement assistance device 100 according to the first embodiment is described with reference to FIG. 2.

FIG. 2 is a block diagram illustrating an example of the configuration of the substantial part of the movement assistance device 100 according to the first embodiment.

The movement assistance device 100 according to the first embodiment is provided with a mobile object sensor information acquiring unit 110, a blind spot area acquiring unit 111, a mobile object position acquiring unit 120, an object sensor information acquiring unit 121, a blind spot object acquiring unit 130, a road condition acquiring unit 150, a contact object specifying unit 160, a movement assistance information acquiring unit 170, and a movement assistance information outputting unit 180.

The mobile object sensor information acquiring unit 110 acquires the mobile object sensor information output by the mobile object sensor 20, which is the sensor provided on the vehicle 10 as the mobile object.

Specifically, the mobile object sensor information acquiring unit 110 acquires the mobile object sensor information output by the mobile object sensor 20 via the network 80.

The blind spot area acquiring unit 111 acquires blind spot area information indicating the blind spot area, which is the area in the blind spot of the mobile object sensor 20, on the basis of the mobile object sensor information acquired by the mobile object sensor information acquiring unit 110.

Specifically, for example, the blind spot area acquiring unit 111 acquires the blind spot area information by calculating the blind spot area using the mobile object sensor information.

The blind spot area of the mobile object sensor 20 is an area in which, due to an obstacle present between the mobile object sensor 20 and a certain area, an object present in the area is not imaged in the image imaged by the mobile object sensor 20 in a case where the mobile object sensor 20 is the imaging device, for example. The blind spot area of the mobile object sensor 20 is an area in which, due to an obstacle present between the mobile object sensor 20 and a certain area, a prospecting wave output by the mobile object sensor 20 does not reach an object present in the area in a case where the mobile object sensor 20 is the ranging sensor, for example.

The obstacle is, for example, a structure such as a signboard, a utility pole, or a traffic light installed on the road on which the vehicle 10 is traveling, a structure such as a house, a fence, or a building present at a position adjacent to the road on which the vehicle 10 is traveling, another traveling or stopped vehicle present on the road on which the vehicle 10 is traveling or the like, for example.

The blind spot area information acquired by the blind spot area acquiring unit 111 is information indicating an area indicated by a relative position based on a predetermined position in the vehicle 10. In the first embodiment, it is described on the premise that the predetermined position in the vehicle 10 as a reference is the position in the vehicle 10 of the mobile object sensor 20 installed on the vehicle 10.

Note that, a method of calculating the blind spot area of the mobile object sensor 20 using the mobile object sensor information output by the mobile object sensor 20, which is the imaging device, the ranging sensor or the like, is known, so that the description thereof is omitted.

The mobile object position acquiring unit 120 acquires the mobile object position information indicating the position of the traveling vehicle 10.

Specifically, for example, the mobile object position acquiring unit 120 acquires the mobile object position information output by the mobile object position outputting device 30 via the network 80.

The object sensor information acquiring unit 121 acquires object sensor information output by the object sensor 90, which is the sensor provided on an object other than the vehicle 10 as the mobile object.

Specifically, for example, the object sensor information acquiring unit 121 acquires the object sensor information output by the object sensor 90 from the object sensor 90 via the network 80. In a case where the object sensor information output by the object sensor 90 is stored in the storage device 40, the object sensor information acquiring unit 121 may acquire the object sensor information by reading the object sensor information stored in the storage device 40 from the storage device 40 via the network 80.

The blind spot object acquiring unit 130 acquires blind spot object information indicating a position or a type of each of one or more objects present in the blind spot area indicated by the blind spot area information acquired by the blind spot area acquiring unit 111. Hereinafter, the object present in the blind spot area is referred to as a “blind spot object”.

The blind spot object information acquired by the blind spot object acquiring unit 130 is information corresponding to each of one or more blind spot objects.

The type of the blind spot object is a movable mobile object such as a pedestrian, a small vehicle such as a bicycle, a motorcycle, and a passenger car, or a large vehicle such as a bus or a truck, and a stationary object that does not move such as an installation such as a signboard, or a structure such as a pillar.

An example of a method by which the blind spot object acquiring unit 130 acquires the blind spot object information indicating the position of each of the one or more blind spot objects is described.

The blind spot object acquiring unit 130 first acquires a position of an object imaged in an image indicated by image information, which is the object sensor information, or a position of an object present in a search range of the object sensor 90 by performing calculation using the object sensor information acquired by the object sensor information acquiring unit 121.

Note that, a method of acquiring the position of the object imaged in the image indicated by the image information, which is the object sensor information, or a method of acquiring the position of the object present in the search range of the object sensor 90 by using the object sensor information output by the object sensor 90, which is the imaging device, the ranging sensor or the like, is known, so that description thereof is omitted. In a case where the blind spot object acquiring unit 130 acquires the position of the object using the object sensor information, the object sensor information includes information indicating a position of the object sensor 90 that outputs the object sensor information, and information indicating a direction in which the object sensor 90 images, or a direction in which the prospecting wave of the object sensor 90 is output.

The blind spot object acquiring unit 130 obtains a relative position of the object imaged in the image indicated by the image information, which is the object sensor information, or the object present in the search range of the object sensor 90 by converting the position of the object calculated by the blind spot object acquiring unit 130 into a relative position based on the position of the mobile object sensor 20 that may be calculated from the position of the vehicle 10 indicated by the mobile object position information using the mobile object position information acquired by the mobile object position acquiring unit 120.

Next, the blind spot object acquiring unit 130 specifies one or more blind spot objects by comparing the relative position of the object obtained by the blind spot object acquiring unit 130 with the position of the blind spot area.

Next, the blind spot object acquiring unit 130 acquires the blind spot object information by making information indicating the relative position of each of the one or more blind spot objects specified by the blind spot object acquiring unit 130 the blind spot object information corresponding to each of the one or more blind spot objects.

The blind spot object acquiring unit 130 may acquire a moving speed, a moving direction, acceleration or the like of the blind spot object in addition to the position of the blind spot object, and generate the blind spot object information including information indicating the position of the blind spot object and information indicating the moving speed, the moving direction, the acceleration or the like of the blind spot object.

Specifically, for example, the blind spot object acquiring unit 130 acquires the moving speed, the moving direction, the acceleration or the like of the blind spot object by calculating the moving speed, the moving direction, the acceleration or the like of the blind spot object on the basis of the positions of the blind spot object at a plurality of different time points. The blind spot object acquiring unit 130 generates the blind spot object information on the basis of the position, the moving speed, the moving direction, the acceleration or the like of the blind spot object acquired by the blind spot object acquiring unit 130.

Note that, a method of calculating the moving speed, the moving direction, the acceleration or the like of the object on the basis of the positions of the object at a plurality of different time points is known, so that the description thereof is omitted.

For example, the blind spot object acquiring unit 130 may read information indicating the position of the object stored in advance in the storage device 40 from the storage device 40 via the network 80, and obtain the relative position of the object by converting the position indicated by the information indicating the position of the object read from the storage device 40 into the relative position.

For example, the blind spot object acquiring unit 130 may generate the blind spot object information indicating the position, the moving speed, the moving direction, the acceleration or the like of the object by reading the information indicating the position of the object stored in advance in the storage device 40 and the information indicating the moving speed, the moving direction, the acceleration or the like of the object from the storage device 40 via the network 80.

An example of a method by which the blind spot object acquiring unit 130 acquires the blind spot object information indicating the type of each of the one or more blind spot objects is described.

The blind spot object information acquired by the blind spot object acquiring unit 130 is information corresponding to each of one or more blind spot objects.

The type of the blind spot object indicated by the blind spot object information is the pedestrian, the small vehicle such as the bicycle, the motorcycle, and the passenger car, the large vehicle such as the bus or the truck, the stationary object or the like.

For example, the blind spot object acquiring unit 130 first specifies the one or more blind spot objects. A method by which the blind spot object acquiring unit 130 specifies the one or more blind spot objects is as described above. The blind spot object acquiring unit 130 specifies the type of the blind spot object imaged in the image indicated by the image information, which is the object sensor information, using the object sensor information acquired by the object sensor information acquiring unit 121 regarding the one or more blind spot objects specified by the blind spot object acquiring unit 130.

Specifically, for example, the blind spot object acquiring unit 130 specifies the type of the blind spot object by a pattern matching technology and the like using the object sensor information.

Note that, a method of specifying the type of the object using the object sensor information by the pattern matching technology and the like is known, so that the description thereof is omitted.

Next, the blind spot object acquiring unit 130 acquires the blind spot object information by generating the blind spot object information indicating the type of each of the one or more blind spot objects specified by the blind spot object acquiring unit 130 in association with each of the one or more blind spot objects specified by the blind spot object acquiring unit 130.

For example, the blind spot object acquiring unit 130 may read information indicating the type of the object stored in advance in the storage device 40 from the storage device 40 via the network 80 and specify the type of the blind spot object on the basis of information indicated by the information indicating the type of the object read from the storage device 40.

Note that, in a case where the blind spot object acquiring unit 130 acquires the information indicating the position of the object by reading the same from the storage device 40, or in a case where the blind spot object acquiring unit 130 acquires the information indicating the type of the object by reading the same from the storage device 40, the object sensor information acquiring unit 121 is not an essential component in the movement assistance device 100.

The blind spot object acquiring unit 130 may acquire the blind spot object information indicating the position and type of each of the one or more blind spot objects.

The road condition acquiring unit 150 acquires road condition information indicating a condition of the road on which the vehicle 10 travels.

Specifically, for example, the road condition acquiring unit 150 acquires the road condition information by reading the road condition information stored in advance in the storage device 40 from the storage device 40 via the network 80.

The road condition information acquired by the road condition acquiring unit 150 is, for example, information indicating the condition of the road on which the vehicle 10 travels such as a road width, the number of lanes, a road type, presence or absence of a sidewalk, presence or absence of a guardrail of the road on which the vehicle 10 travels, that is, the road on which the mobile object moves, a connection point and a connection state between the road and a road connected to the road, or a road surface condition of whether or not a road surface is wet or whether or not the road surface is paved. The road condition information acquired by the road condition acquiring unit 150 may include information indicating the condition of the road on which the vehicle 10 travels such as a point where a traffic accident occurs or a point where road construction is performed on the road on which the vehicle 10 travels.

The road type includes a general road, an expressway, a highway or the like.

The road condition acquiring unit 150 is not an essential configuration in the movement assistance device 100.

The contact object specifying unit 160 specifies a blind spot object (hereinafter, referred to as a “specific blind spot object”) with which the vehicle 10 that travels might come into contact out of the one or more blind spot objects on the basis of the blind spot object information acquired by the blind spot object acquiring unit 130.

Specifically, for example, the contact object specifying unit 160 specifies a blind spot object with which the vehicle 10 that travels is most likely to come into contact out of the one or more blind spot objects specified by the blind spot object acquiring unit 130 as the specific blind spot object on the basis of the blind spot object information.

In a case where the blind spot object information is the information indicating the position of the blind spot object, for example, the contact object specifying unit 160 calculates a distance from a route on which the vehicle 10 as the mobile object is scheduled to travel to the position of the blind spot object, and specifies a blind spot object at the shortest distance out of the one or more blind spot objects specified by the blind spot object acquiring unit 130 as the specific blind spot object on the basis of the calculated distance.

In a case where the blind spot object information is the information indicating the position, the moving speed, the moving direction, the acceleration or the like of the blind spot object, for example, the contact object specifying unit 160 may calculate the distance from the route on which the vehicle 10 as the mobile object is scheduled to travel to the position of the blind spot object, and may specify as the specific blind spot object the blind spot object with which the vehicle 10 that travels is most likely to come into contact out of the one or more blind spot objects specified by the blind spot object acquiring unit 130 on the basis of the calculated distance and the moving speed, the moving direction, the acceleration or the like.

In a case where the blind spot object information is the information indicating the type of the blind spot object, for example, the contact object specifying unit 160 specifies, as the specific blind spot object, the blind spot object of the type with the highest degree of danger out of the one or more blind spot objects specified by the blind spot object acquiring unit 130 on the basis of the degree of danger determined in advance for each type of the blind spot object. Note that, the information indicating the degree of danger determined in advance for each type of the blind spot object may be held in advance by the contact object specifying unit 160, or may be acquired by the contact object specifying unit 160 reading the information from the storage device 40.

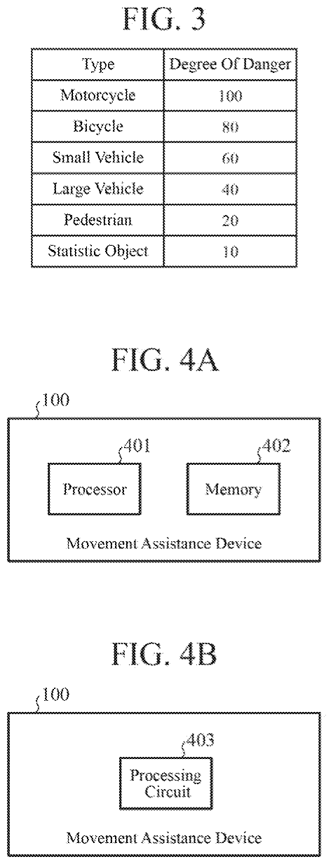

FIG. 3 is a diagram illustrating an example of the degree of danger determined in advance for each type of the blind spot object according to the first embodiment.

For example, in a case where the blind spot object acquiring unit 130 specifies two blind spot objects including a first blind spot object and a second blind spot object, the type indicated by the blind spot object information corresponding to the first blind spot object acquired by the blind spot object acquiring unit 130 is a bicycle, and the type indicated by the blind spot object information corresponding to the second blind spot object acquired by the blind spot object acquiring unit 130 is a pedestrian, the contact object specifying unit 160 specifies, as the specific blind spot object, the first blind spot object, which is the bicycle, having a higher degree of danger corresponding to the type of the blind spot object than that of the pedestrian, which is the second blind spot object.

In a case where the movement assistance device 100 is provided with the road condition acquiring unit 150, the contact object specifying unit 160 may specify the specific blind spot object on the basis of the road condition information acquired by the road condition acquiring unit 150 in addition to the blind spot object information.

There is a case where the road condition information is information indicating that there is a guardrail on the road on which the vehicle 10 is traveling, and a position of a certain blind spot object out of the one or more blind spot objects is on the opposite side of the route on which the vehicle 10 is scheduled to travel with respect to the guardrail.

In such a case, the contact object specifying unit 160 specifies the specific blind spot object out of the one or more blind spot objects other than the blind spot object the position of which is on the opposite side of the route on which the vehicle 10 is scheduled to travel with respect to the guardrail.

With such a configuration, the movement assistance device 100 can specify the specific blind spot object with high accuracy.

There is a case where the type indicated by the blind spot object information corresponding to the blind spot object acquired by the blind spot object acquiring unit 130 is specified as a wrong type by the pattern matching technology and the like.

Specifically, for example, in a case where the road type of the road on which the vehicle 10 is traveling indicated by the road condition information is the road on which a pedestrian or a bicycle is not present such as the expressway or highway, the contact object specifying unit 160 specifies the specific blind spot object out of the blind spot objects other than the blind spot object the type of which indicated by the blind spot object information corresponding to the blind spot object acquired by the blind spot object acquiring unit 130 is the pedestrian or bicycle.

With such a configuration, the movement assistance device 100 can specify the specific blind spot object with high accuracy.

For example, in a case where the road type of the road on which the vehicle 10 is traveling indicated by the road type indicated by the road condition information is the road on which the pedestrian or bicycle is not present such as the expressway or highway but is near the point in which the road construction is performed on the road on which the vehicle 10 travels indicated by the road condition information, the contact object specifying unit 160 specifies the specific blind spot object out of the one or more blind spot objects including the blind spot object the type of which indicated by the blind spot object information corresponding to the blind spot object acquired by the blind spot object acquiring unit 130 is the pedestrian or bicycle.

With such a configuration, the movement assistance device 100 can specify the specific blind spot object with high accuracy.

In a case where the blind spot object information acquired by the blind spot object acquiring unit 130 is the information indicating the position and type of each of the one or more blind spot objects, the contact object specifying unit 160 may specify the specific blind spot object on the basis of the position and type of each of the one or more blind spot objects indicated by the blind spot object information.

Specifically, for example, in a case where the blind spot object acquiring unit 130 specifies the two blind spot objects including the first blind spot object and the second blind spot object, and the type indicated by the blind spot object information corresponding to the first blind spot object acquired by the blind spot object acquiring unit 130 is the same as the type indicated by the blind spot object information corresponding to the second blind spot object acquired by the blind spot object acquiring unit 130, the contact object specifying unit 160 compares the position of the first blind spot object indicated by the blind spot object information corresponding to the first blind spot object acquired by the blind spot object acquiring unit 130 with the position of the second blind spot object indicated by the blind spot object information corresponding to the second blind spot object acquired by the blind spot object acquiring unit 130, and specifies that the blind spot object of a shorter distance from the route on which the vehicle 10 is scheduled to travel to the position of the blind spot object is the specific blind spot object.

The movement assistance information acquiring unit 170 acquires the movement assistance information for avoiding contact of the vehicle 10 with the specific blind spot object on the basis of the blind spot object information corresponding to the object specified by the contact object specifying unit 160.

The movement assistance for avoiding the contact of the vehicle 10 with the specific blind spot object differs for each position or type of the specific blind spot object.

For example, the movement assistance for avoiding the contact of the vehicle 10 with the specific blind spot object differs between a case where the specific blind spot object present in the blind spot area generated by another vehicle traveling on the road on which the vehicle 10 is traveling is present on the route on which the vehicle 10 is scheduled to travel and a case where this is present at an edge of the road on which the vehicle 10 is scheduled to travel. Specifically, for example, in order to avoid the contact of the vehicle 10 with the specific blind spot object present on the route on which the vehicle 10 is scheduled to travel, it is necessary to perform the movement assistance to greatly turn the steering wheel to allow the vehicle 10 to travel as compared with a case of avoiding the contact of the vehicle 10 with the specific blind spot object present at the edge of the road on which the vehicle 10 is scheduled to travel.

For example, in a case where the specific blind spot object is present at a position relatively close to the vehicle 10, a period for avoiding the contact of the vehicle 10 with the specific blind spot object is shorter than that in a case where the specific blind spot object is present at a position relatively far from the vehicle 10. Therefore, in a case where the specific blind spot object is present at the position relatively close to the vehicle 10, as compared with a case where the specific blind spot object is present at the position relatively far from the vehicle 10, for example, it is necessary to perform the movement assistance for increasing a ratio of reduction in speed at which the vehicle 10 travels, or it is necessary to perform the movement assistance for increasing a ratio of change in the direction in which the vehicle 10 travels.

For example, a motorcycle or a bicycle has a higher degree of freedom in changing a moving direction than that of a small vehicle or a large vehicle. Therefore, in a case where the type of the specific blind spot object is the motorcycle or the bicycle, in order to avoid the contact of the vehicle 10 with the specific blind spot object, as compared with a case where the type of the specific blind spot object is the small vehicle or the large vehicle, for example, it is necessary to perform the movement assistance for allowing the vehicle 10 to travel at a position away from the specific blind spot object, or it is necessary to perform the movement assistance for allowing the vehicle 10 to travel at a sufficiently reduced speed.

For example, the motorcycle has a higher degree of freedom in changing the moving speed than that of the bicycle. Therefore, in a case where the type of the specific blind spot object is the motorcycle, in order to avoid the contact of the vehicle 10 with the specific blind spot object, as compared with a case where the type of the specific blind spot object is the bicycle, for example, it is necessary to perform the movement assistance for allowing the vehicle 10 to travel at a position away from the specific blind spot object, or it is necessary to perform the movement assistance for allowing the vehicle 10 to travel at a sufficiently reduced speed.

The movement assistance for avoiding the contact of the vehicle 10 with the specific blind spot object differs depending on the position and type of the specific blind spot object.

This is because, for example, even when the specific blind spot objects are of the same type, the movement assistance necessary for avoiding the contact of the vehicle 10 with the specific blind spot object varies depending on the position of the specific blind spot object.

The movement assistance information acquiring unit 170 inputs the blind spot object information corresponding to the specific blind spot object to a learned model, and acquires the movement assistance information output by the learned model as an inference result. For example, the movement assistance information acquiring unit 170 acquires learned model information by reading the learned model information indicating the learned model stored in the storage device 40 in advance from the storage device 40. The movement assistance information acquiring unit 170 may hold the learned model in advance.

With such a configuration, the movement assistance device 100 can acquire the movement assistance information depending on the position or type of the specific blind spot object.

In a case where the blind spot object acquiring unit 130 acquires the blind spot object information indicating the position and type of each of the one or more blind spot objects, the movement assistance information acquiring unit 170 can input the blind spot object information corresponding to the specific blind spot object to the learned model and acquire the movement assistance information output as the inference result by the learned model, so that the movement assistance device 100 can acquire the movement assistance information depending on the position and type of the specific blind spot object.

In a case where the movement assistance device 100 is provided with the road condition acquiring unit 150, the movement assistance information acquiring unit 170 may input the road condition information acquired by the road condition acquiring unit 150 to the learned model in addition to the blind spot object information corresponding to the specific blind spot object, and acquire the movement assistance information output as the inference result by the learned model.

The movement assistance for avoiding the contact of the vehicle 10 with the specific blind spot object differs depending on the condition of the road on which the vehicle 10 travels.

Specifically, for example, the movement assistance for avoiding the contact of the vehicle 10 with the specific blind spot object differs depending on the road width and the like of the road on which the vehicle 10 travels.

For example, in a case where the road width of the road on which the vehicle 10 travels is relatively narrow, there is a case where the vehicle 10 cannot travel sufficiently away from the specific blind spot object as compared with a case where the road width of the road on which the vehicle 10 travels is relatively wide. Therefore, in a case where the road width of the road on which the vehicle 10 travels is relatively narrow, as compared with a case where the road width of the road on which the vehicle 10 travels is relatively wide, for example, it is necessary to give a priority to the movement assistance of reducing the speed at which the vehicle 10 travels over the movement assistance of changing the direction in which the vehicle 10 travels.

The movement assistance information acquiring unit 170 acquires the movement assistance information for avoiding the contact of the vehicle 10 with the specific blind spot object on the basis of the road condition information acquired by the road condition acquiring unit 150 in addition to the blind spot object information corresponding to the specific blind spot object, so that the movement assistance device 100 can acquire the movement assistance information depending on not only the position or type of the specific blind spot object but also the condition of the road on which the vehicle 10 travels.

The movement assistance information outputting unit 180 outputs the movement assistance information acquired by the movement assistance information acquiring unit 170.

Specifically, for example, the movement assistance information outputting unit 180 outputs the movement assistance information to the automatic movement controlling device 50, the display controlling device 60, the sound output controlling device 70 or the like via the network 80.

For example, the automatic movement controlling device 50 performs, in response to the movement assistance information output by the movement assistance information outputting unit 180, the vehicle control such as the steering control, brake control, accelerator control, or horn control on the vehicle 10 on the basis of the movement assistance information.

For example, the display controlling device 60 generates, in response to the movement assistance information output by the movement assistance information outputting unit 180, the display image signal based on the movement assistance information, and outputs the generated display image signal to a display device not illustrated.

For example, the sound output controlling device 70 generates, in response to the movement assistance information output by the movement assistance information outputting unit 180, the sound signal based on the movement assistance information, and outputs the generated sound signal to a sound outputting device not illustrated.

A hardware configuration of the substantial part of the movement assistance device 100 according to the first embodiment is described with reference to FIGS. 4A and 4B.

FIGS. 4A and 4B are diagrams illustrating an example of the substantial part of the hardware configuration of the movement assistance device 100 according to the first embodiment.

As illustrated in FIG. 4A, the movement assistance device 100 is formed of a computer, and the computer includes a processor 401 and a memory 402. The memory 402 stores a program that allows the computer to serve as the mobile object sensor information acquiring unit 110, the blind spot area acquiring unit 111, the mobile object position acquiring unit 120, the object sensor information acquiring unit 121, the blind spot object acquiring unit 130, the road condition acquiring unit 150, the contact object specifying unit 160, the movement assistance information acquiring unit 170, and the movement assistance information outputting unit 180. The processor 401 reads the program stored in the memory 402 to execute, so that the mobile object sensor information acquiring unit 110, the blind spot area acquiring unit 111, the mobile object position acquiring unit 120, the object sensor information acquiring unit 121, the blind spot object acquiring unit 130, the road condition acquiring unit 150, the contact object specifying unit 160, the movement assistance information acquiring unit 170, and the movement assistance information outputting unit 180 arc implemented.

As illustrated in FIG. 4B, the movement assistance device 100 may be formed of a processing circuit 403. In this case, functions of the mobile object sensor information acquiring unit 110, the blind spot area acquiring unit 111, the mobile object position acquiring unit 120, the object sensor information acquiring unit 121, the blind spot object acquiring unit 130, the road condition acquiring unit 150, the contact object specifying unit 160, the movement assistance information acquiring unit 170, and the movement assistance information outputting unit 180 may be implemented by the processing circuit 403.

The movement assistance device 100 may be formed of the processor 401, the memory 402, and the processing circuit 403 (not illustrated). In this case, a part of the functions of the mobile object sensor information acquiring unit 110, the blind spot area acquiring unit 111, the mobile object position acquiring unit 120, the object sensor information acquiring unit 121, the blind spot object acquiring unit 130, the road condition acquiring unit 150, the contact object specifying unit 160, the movement assistance information acquiring unit 170, and the movement assistance information outputting unit 180 may be implemented by the processor 401 and the memory 402, and the remaining functions may be implemented by the processing circuit 403.

The processor 401 uses, for example, a central processing unit (CPU), a graphics processing unit (GPU), microprocessor, a microcontroller, a digital signal processor (DSP) or the like.

The memory 402 uses, for example, a semiconductor memory or a magnetic disk. More specifically, the memory 402 uses a random access memory (RAM), a read only memory (ROM), a flash memory, an erasable programmable read only memory (EPROM), an electrically erasable programmable read-only memory (EEPROM), an SSD, a HDD or the like.

The processing circuit 403 uses, for example, an application specific integrated circuit (ASIC), a programmable logic device (PLD), a field-programmable gate array (FPGA), a system-on-a-chip (SoC), or a system large-scale integration (LSI).

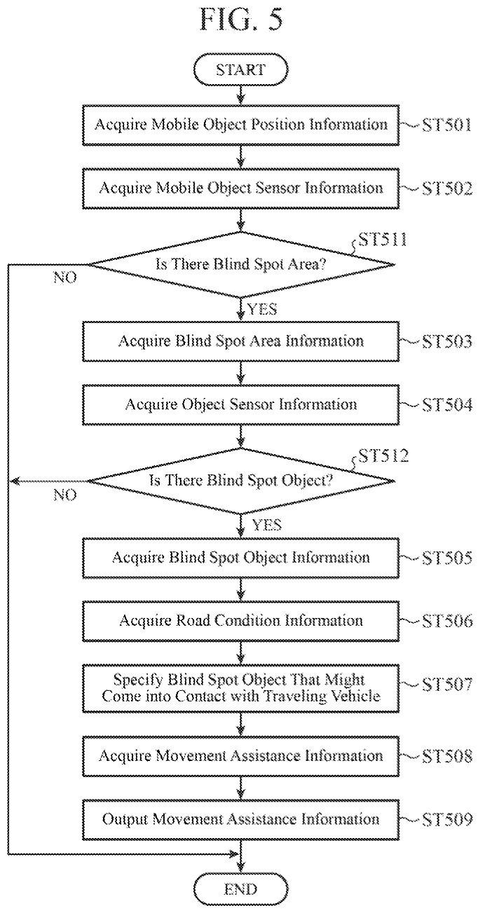

An operation of the movement assistance device 100 according to the first embodiment is described with reference to FIG. 5.

FIG. 5 is a flowchart illustrating an example of processing of the movement assistance device 100 according to the first embodiment.

The movement assistance device 100 repeatedly executes the flowchart while the vehicle 10 is traveling.

First, at step ST501, the mobile object position acquiring unit 120 acquires the mobile object position information.

Next, at step ST502, the mobile object sensor information acquiring unit 110 acquires the mobile object sensor information.

Next, at step ST511, the blind spot area acquiring unit 111 determines whether or not there is the blind spot area.

At step ST511, in a case where the blind spot area acquiring unit 111 determines that there is no blind spot area, the movement assistance device 100 finishes the processing of the flowchart. After finishing the processing of the flowchart, the movement assistance device 100 returns to the processing at step ST501 and repeatedly executes the processing of the flowchart.

At step ST511, in a case where the blind spot area acquiring unit 111 determines that there is the blind spot area, the blind spot area acquiring unit 111 acquires the blind spot area information at step ST503.

After step ST503, at step ST504, the object sensor information acquiring unit 121 acquires the object sensor information.

After step ST504, at step ST512, the blind spot object acquiring unit 130 determines whether or not there is the blind spot object.

At step ST512, in a case where the blind spot object acquiring unit 130 determines that there is no blind spot object, the movement assistance device 100 finishes the processing of the flowchart. After finishing the processing of the flowchart, the movement assistance device 100 returns to the processing at step ST501 and repeatedly executes the processing of the flowchart.

At step ST512, in a case where the blind spot object acquiring unit 130 determines that there is the blind spot object, the blind spot object acquiring unit 130 acquires the blind spot object information at step ST505.

After step ST505, at step ST506, the road condition acquiring unit 150 acquires the road condition information.

After step ST506, at step ST507, the contact object specifying unit 160 specifies the blind spot object with which the vehicle 10 that travels might come into contact out of the one or more blind spot objects.

After step ST507, at step ST508, the movement assistance information acquiring unit 170 acquires the movement assistance information.

After step ST508, at step ST509, the movement assistance information outputting unit 180 outputs the movement assistance information.

After the processing at step ST509, the movement assistance device 100 finishes the processing of the flowchart. After finishing the processing of the flowchart, the movement assistance device 100 returns to the processing at step ST501 and repeatedly executes the processing of the flowchart.

Note that, the processing at step ST501 may be performed at any timing before the processing at step ST505 is performed.

The processing at step ST504 may be performed at any timing before the processing at step ST505 is performed.

The processing at step ST506 may be performed at any timing before the processing at step ST507 or step ST508 is performed.

In a case where the movement assistance device 100 is not provided with the object sensor information acquiring unit 121, the processing at step ST504 is omitted.

In a case where the movement assistance device 100 is not provided with the road condition acquiring unit 150, the processing at step ST506 is omitted.

The learned model used when the movement assistance information acquiring unit 170 acquires the movement assistance information is generated by the movement assistance learning device 200, for example.

The movement assistance learning device 200 according to the first embodiment is described with reference to FIGS. 6 to 8.

FIG. 6 is a block diagram illustrating an example of a substantial part of a movement assistance learning system 2 to which the movement assistance learning device 200 according to the first embodiment is applied.

The movement assistance learning system 2 according to the first embodiment is provided with the movement assistance learning device 200, the vehicle 10, the mobile object sensor 20, the mobile object position outputting device 30, the storage device 40, the network 80, and the object sensor 90.

In a configuration of the movement assistance learning system 2 according to the first embodiment, the configuration similar to that of the movement assistance system 1 according to the first embodiment is assigned with the same reference numeral, and redundant description thereof is omitted. That is, the description of the configuration in FIG. 6 assigned with the same reference numeral as that in FIG. 1 is omitted.

The movement assistance learning device 200 generates the learned model capable of outputting the movement assistance information for avoiding the contact of the vehicle 10 as the mobile object with an object.

The movement assistance learning device 200 generates the learned model by changing a parameter of a learning model formed of a neural network prepared in advance, for example, by allowing the same to learn by deep learning.

The movement assistance learning device 200 may be installed in the vehicle 10 or may be installed in a predetermined place outside the vehicle 10. In the first embodiment, it is described on the premise that the movement assistance learning device 200 is installed in the predetermined place outside the vehicle 10.

A configuration of a substantial part of the movement assistance learning device 200 according to the first embodiment is described with reference to FIG. 7.

FIG. 7 is a block diagram illustrating an example of the configuration of the substantial part of the movement assistance learning device 200 according to the first embodiment.

The movement assistance learning device 200 according to the first embodiment is provided with an object acquiring unit 210, a learning unit 230, and a learned model outputting unit 240.

The object acquiring unit 210 acquires object information indicating a position or a type of an object. The position of the object indicated by the object information is, for example, a relative position based on a predetermined position in the vehicle 10. The type of the object indicated by the object information is, for example, a movable mobile object such as a pedestrian, a small vehicle such as a bicycle, a motorcycle, and a passenger car, or a large vehicle such as a bus or a truck, and a stationary object that does not move such as an installation such as a signboard, or a structure such as a pillar.

Specifically, for example, the object acquiring unit 210 acquires the object information by reading the object information stored in advance from the storage device 40 via the network 80.

The object acquiring unit 210 may acquire the mobile object sensor information output by the mobile object sensor 20 or the object sensor information output by the object sensor 90, and acquire the object information by specifying the position or type of the object present in a predetermined area around the vehicle 10 using the mobile object sensor information or the object sensor information. For example, the object acquiring unit 210 may acquire the mobile object sensor information output by the mobile object sensor 20 or the object sensor information output by the object sensor 90, and acquire the object information by specifying the position or type of the object present in the predetermined area around the vehicle 10 using the mobile object sensor information or the object sensor information.

In a case where the object acquiring unit 210 acquires the object information indicating the position of the object, for example, the object acquiring unit 210 acquires the mobile object position information output by the mobile object position outputting device 30, and acquires the object information by converting the position of the object acquired using the mobile object sensor information, the object sensor information or the like into a relative position based on a predetermined position in the vehicle 10 using the mobile object position information.

Note that, a method of specifying the position of the object using the mobile object sensor information or the object sensor information, and a method of specifying the type of the object using the mobile object sensor information or the object sensor information are known, so that the description thereof is omitted.

The learning unit 230 generates, on the basis of the object information acquired by the object acquiring unit 210, the learned model capable of outputting the movement assistance information for avoiding the contact of the vehicle 10 as the mobile object with the object.

Specifically, for example, the learning unit 230 generates the learned model through learning of the object information as training data.

More specifically, for example, the learning unit 230 generates the learned model by changing the parameter of the learning model by allowing the same to learn the object information as the training data.

With such a configuration, the movement assistance learning device 200 can generate the learned model corresponding to each position or each type of the object.

Note that, an initial learning model is stored in the storage device 40 in advance, for example, and the learning unit 230 acquires the initial learning model by reading the initial learning model from the storage device 40 via the network 80.

The learned model outputting unit 240 outputs the learned model generated by the learning unit 230.

Specifically, for example, the learned model outputting unit 240 outputs the learned model generated by the learning unit 230 to the storage device 40 via the network 80 and stores the same in the storage device 40.

In a case where the movement assistance learning device 200 generates the learned model through learning of the object information indicating the position of the object present in the predetermined area around the vehicle 10 as the training data, for example, the movement assistance device 100 inputs the blind spot object information indicating the position of the blind spot object to the learned model and acquires the movement assistance information output by the learned model as the inference result.

In a case where the movement assistance learning device 200 generates the learned model through learning of the object information indicating the type of the object present in the predetermined area around the vehicle 10 as the training data, for example, the movement assistance device 100 inputs the blind spot object information indicating the type of the blind spot object to the learned model and acquires the movement assistance information output by the learned model as the inference result.

Note that, the learning unit 230 described so far generates the learned model through learning of the object information indicating the position or type of the object present in the predetermined area around the vehicle 10 as the training data.

The learning unit 230 may also generate the learned model through learning of the object information indicating the moving speed, the moving direction, the acceleration or the like of the object in addition to the position of the object present in the predetermined area around the vehicle 10 as the training data.

In a case where the learning unit 230 allows learning of the object information indicating the moving speed, the moving direction, the acceleration or the like of the object in addition to the position of the object present in the predetermined area around the vehicle 10 as the training data, the object acquiring unit 210 acquires the object information indicating the moving speed, the moving direction, the acceleration or the like of the object in addition to the position of the object present in the predetermined area around the vehicle 10.

The learning unit 230 can generate the learned model capable of performing the movement assistance with higher accuracy when the learning unit 230 allows learning of the object information indicating the moving speed, the moving direction, the acceleration or the like of the object in addition to the position of the object present in the predetermined area around the vehicle 10 as the training data.

In a case where the movement assistance learning device 200 generates the learned model through learning of the object information indicating the moving speed, the moving direction, the acceleration or the like of the object in addition to the position of the object present in the predetermined area around the vehicle 10 as the training data, for example, the movement assistance device 100 inputs the blind spot object information indicating the moving speed, the moving direction, the acceleration or the like of the blind spot object in addition to the position of the blind spot object to the learned model and acquires the movement assistance information output by the learned model as the inference result.

With such a configuration, the movement assistance device 100 can acquire the movement assistance information for performing the movement assistance with higher accuracy.

The learning unit 230 described so far generates the learned model through learning of the object information indicating the position or type of the object as the training data regarding the object present in the predetermined area around the vehicle 10 regardless of whether or not this is the object present in the blind spot area of the mobile object sensor 20 provided on the vehicle 10.

The learning unit 230 may also generate the learned model through learning of the object information indicating the position or type of the blind spot object as the training data regarding the object present in the blind spot area of the mobile object sensor 20 provided on the vehicle 10, that is, the blind spot object.

The learning unit 230 allows learning of the object information indicating the position or type of the blind spot object as the training data, so that the learning unit 230 can generate the learned model capable of performing the movement assistance with higher accuracy.

In a case where the movement assistance learning device 200 generates the learned model through learning of the object information indicating the position or type of the blind spot object as the training data, the object acquiring unit 210 provided on the movement assistance learning device 200 has a function equivalent to that of the blind spot object acquiring unit 130 provided on the movement assistance device 100, for example.

In this case, the movement assistance learning device 200 includes, for example, a means having functions of the mobile object sensor information acquiring unit 110, the blind spot area acquiring unit 111, the object sensor information acquiring unit 121, and the contact object specifying unit 160 provided on the movement assistance device 100.

The movement assistance learning device 200 generates the learned model through learning of the object information indicating the position or type of the blind spot object as the training data, so that the movement assistance device 100 can acquire the movement assistance information for performing the movement assistance with higher accuracy.

The movement assistance learning device 200 is provided with a unit for acquiring the road condition information indicating the condition of the road on which the vehicle 10 travels such as the road width, the number of lanes, the road type, and the presence or absence of the sidewalk of the road on which the vehicle 10 travels, or the connection point and the connection state between the road and the road connected to the road, and the learning unit 230 may generate the learned model through learning of the road condition information as the training data in addition to the object information.

In a case where the movement assistance learning device 200 generates the learned model through learning of the object information and the road condition information as the training data, for example, the movement assistance device 100 inputs the blind spot object information and the road condition information to the learned model and acquires the movement assistance information output by the learned model as the inference result.

With such a configuration, the movement assistance device 100 can acquire the movement assistance information for performing the movement assistance with higher accuracy.

A learning method with which the learning unit 230 allows the learning model to learn is described.

For example, the learning unit 230 generates the learned model by supervised learning.

For example, teacher data used for the supervised learning by the learning unit 230 is movement assistance information for teacher indicating appropriate movement assistance prepared in advance for each type of the object or each position of the object.

In a case where the learning unit 230 generates the learned model by the supervised learning, the learning unit 230 compares the movement assistance information as the inference result output by the learning model with the movement assistance information for teacher as the teacher data, thereby generating the learned model by changing the parameter of the learning model.

In this case, for example, the learning unit 230 acquires the teacher data used for the supervised learning by reading the teacher data stored in advance in the storage device 40 via the network 80.

The learning unit 230 may generate the learned model by reinforcement learning.

In a case where the learning unit 230 generates the learned model by the reinforcement learning, the learning unit 230 gives a positive reward in a case where the contact of the vehicle 10 with an object corresponding to the object information input to the learning model can be avoided by the inference result output by the learning model, and gives a negative reward in a case where the contact of the vehicle 10 with the object cannot be avoided. The learning unit 230 generates the learned model by changing the parameter of the learning model by repeating the above-described learning.

The learning unit 230 may also generate the learned model by inverse reinforcement learning.

In a case where the learning unit 230 generates the learned model by the inverse reinforcement learning, the learning unit 230 estimates a reward to be given by comparing the movement assistance information as the inference result output by the learning model with a plurality of pieces of appropriate movement assistance information as elements of successful movement assistance information, using the successful movement assistance information that is a set of a plurality of pieces of appropriate movement assistance information prepared in advance for each type of the object or each position of the object. The learning unit 230 generates the learned model by changing the parameter of the learning model by repeating the above-described learning.

In this case, for example, the learning unit 230 acquires the successful movement assistance information used for the inverse reinforcement learning by reading the successful movement assistance information stored in advance in the storage device 40 via the network 80.

Each function of the object acquiring unit 210, the learning unit 230, and the learned model outputting unit 240 provided on the movement assistance learning device 200 may be implemented by the processor 401 and the memory 402 or may be implemented by the processing circuit 403 in the hardware configuration an example of which is illustrated in FIGS. 4A and 4B as in the hardware configuration of the movement assistance device 100.

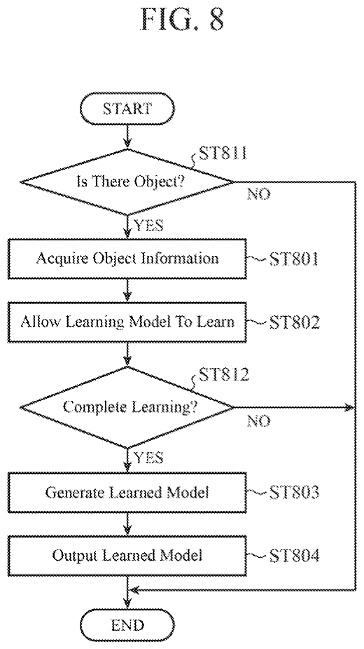

An operation of the movement assistance learning device 200 according to the first embodiment is described with reference to FIG. 8.

FIG. 8 is a flowchart illustrating an example of processing of the movement assistance learning device 200 according to the first embodiment.

The movement assistance learning device 200 generates the learned model by repeatedly executing the flowchart while the vehicle 10 is traveling until the learned model is generated.

First, at step ST811, the object acquiring unit 210 determines whether or not there is an object in the predetermined area around the vehicle 10.

At step ST811, in a case where the object acquiring unit 210 determines that there is no object in the predetermined area around vehicle 10, the movement assistance learning device 200 finishes the processing of the flowchart. After finishing the processing of the flowchart, the movement assistance learning device 200 returns to the processing at step ST811 and repeatedly executes the processing of the flowchart.

At step ST811, in a case where the object acquiring unit 210 determines that there is the object in the predetermined area around the vehicle 10, the object acquiring unit 210 acquires the object information at step ST801.

Next, at step ST802, the learning unit 230 inputs the object information to the learning model and allows the learning model to learn.

Next, at step ST812, the learning unit 230 determines whether or not the learning of the learning model is completed. Specifically, for example, the learning unit 230 determines whether or not learning of the learning model is completed by determining whether or not the learning model is allowed to learn the predetermined number of learnings. For example, the learning unit 230 determines whether or not the learning of the learning model is completed by determining whether or not a user performs an operation indicating completion of learning via an input device not illustrated.

At step ST812, in a case where the learning unit 230 determines that the learning of the learning model is not completed, the movement assistance learning device 200 finishes the processing of the flowchart. After finishing the processing of the flowchart, the movement assistance learning device 200 returns to the processing at step ST811 and repeatedly executes the processing of the flowchart.

At step ST812, in a case where the learning unit 230 determines that the learning of the learning model is completed, at step ST803, the learning unit 230 generates the learned model by making the learning model the learned model.

After the processing at step ST803, at step ST804, the learned model outputting unit 240 outputs the learned model.

After the processing at step ST804, the movement assistance learning device 200 finishes the processing of the flowchart.

As described above, the movement assistance device 100 is provided with the mobile object sensor information acquiring unit 110 that acquires the mobile object sensor information output by the mobile object sensor 20, which is the sensor provided on the mobile object; the blind spot area acquiring unit 111 that acquires the blind spot area information indicating the blind spot area of the mobile object sensor 20 on the basis of the mobile object sensor information acquired by the mobile object sensor information acquiring unit 110; the blind spot object acquiring unit 130 that acquires the blind spot object information indicating the position or type of each of the one or more objects present in the blind spot area indicated by the blind spot area information acquired by the blind spot area acquiring unit 111; the contact object specifying unit 160 that specifies an object with which the mobile object might come into contact when the mobile object moves out of the one or more objects present in the blind spot area on the basis of the blind spot object information acquired by the blind spot object acquiring unit 130; the movement assistance information acquiring unit 170 that inputs the blind spot object information corresponding to the object specified by the contact object specifying unit 160 to the learned model and acquires the movement assistance information that is the information output by the learned model as the inference result, the information for avoiding the contact of the mobile object with the object; and the movement assistance information outputting unit 180 that outputs the movement assistance information acquired by the movement assistance information acquiring unit 170.

With such a configuration, the movement assistance device 100 can perform advanced movement assistance in consideration of a condition of the area in the blind spot as seen from the moving mobile object including the traveling vehicle 10.

With such a configuration, the movement assistance device 100 can perform the advanced movement assistance corresponding to the type of the object in consideration of the position of the object present in the area in the blind spot as seen from the moving mobile object including the traveling vehicle 10.

With such a configuration, the movement assistance device 100 can perform the advanced movement assistance corresponding to the type of the object in consideration of the type of the object present in the area in the blind spot as seen from the moving mobile object including the traveling vehicle 10.

With such a configuration, the movement assistance device 100 can perform the advanced movement assistance corresponding to the position, the moving direction, the moving speed, the acceleration or the like of the object in consideration of the moving direction, the moving speed, the acceleration or the like of the object in addition to the position of the object present in the area in the blind spot as seen from the moving mobile object including the traveling vehicle 10.

In the above-described configuration, the movement assistance device 100 is configured so that the blind spot object acquiring unit 130 acquires the blind spot object information indicating the position and type of each of the one or more objects present in the blind spot area indicated by the blind spot area information acquired by the blind spot area acquiring unit 111, the contact object specifying unit 160 specifies an object with which the mobile object might come into contact when the mobile object moves out of the one or more objects present in the blind spot area on the basis of the position or type of each of the one or more objects present in the blind spot area indicated by the blind spot object information acquired by the blind spot object acquiring unit 130, and the movement assistance information acquiring unit 170 inputs the blind spot object information corresponding to the object specified by the contact object specifying unit 160 to the learned model and acquires the movement assistance information output as the inference result by the learned model.

With such a configuration, the movement assistance device 100 can perform the advanced movement assistance corresponding to the position and type of the object in consideration of the position and type of the object present in the area in the blind spot as seen from the moving mobile object including the traveling vehicle 10.

The movement assistance device 100 is provided with, in addition to the above-described configuration, the road condition acquiring unit 150 that acquires the road condition information indicating the condition of the road on which the vehicle 10 travels, and the contact object specifying unit 160 is configured to specify an object with which the mobile object might come into contact when the mobile object moves out of the one or more objects present in the blind spot area on the basis of the road condition information acquired by the road condition acquiring unit 150 in addition to the blind spot object information.

With such a configuration, the movement assistance device 100 can specify the object with which the mobile object might come into contact with high accuracy out of the one or more objects present in the area in the blind spot as seen from the moving mobile object including the traveling vehicle 10, so that this can perform the advanced movement assistance corresponding to the position or type of the object with high accuracy in consideration of the position or type of the mobile object.

The movement assistance device 100 is provided with, in addition to the above-described configuration, the road condition acquiring unit 150 that acquires the road condition information indicating the condition of the road on which the vehicle 10 travels, and the movement assistance information acquiring unit 170 is configured to input the road condition information acquired by the road condition acquiring unit 150 to the learned model in addition to the blind spot object information corresponding to the object specified by the contact object specifying unit 160 and acquire the movement assistance information output as the inference result by the learned model.

With such a configuration, the movement assistance device 100 can perform the advanced movement assistance corresponding to the position or type of the object and the condition of the road on which the vehicle 10 travels in consideration of the condition of the road on which the vehicle 10 travels in addition to the position or type of the object present in the area in the blind spot as seen from the moving mobile object including the traveling vehicle 10.

In addition to the above-described configuration, the movement assistance device 100 is provided with the object sensor information acquiring unit 121 that acquires the object sensor information output by the object sensor 90, which is a sensor provided on an object other than the vehicle 10, and the blind spot object acquiring unit 130 is configured to acquire the blind spot object information indicating the position or type of each of the one or more objects present in the blind spot area indicated by the blind spot area information on the basis of the object sensor information acquired by the object sensor information acquiring unit 121.

With such a configuration, the movement assistance device 100 can acquire the position and type of the one or more objects present in the blind spot area even in a case where the information indicating the position or type of the one or more objects present in the area in the blind spot as seen from the moving mobile object including the traveling vehicle 10 is not prepared in advance, so that this can perform the advanced movement assistance corresponding to the type of the object in consideration of the type of the object present in the area in the blind spot as seen from the moving mobile object including the traveling vehicle 10.

As described above, the movement assistance learning device 200 is provided with the object acquiring unit 210 that acquires the object information indicating the position or type of the object, and the learning unit 230 that generates the learned model capable of outputting the movement assistance information for avoiding the contact of the mobile object with the object through learning of the object information acquired by the object acquiring unit 210 as the training data.

With such a configuration, the movement assistance learning device 200 can provide the learned model enabling the movement assistance device 100 to perform the advanced movement assistance in consideration of the condition of the area in the blind spot as seen from the moving mobile object including the traveling vehicle 10.

With such a configuration, the movement assistance learning device 200 can provide the learned model enabling the movement assistance device 100 to perform the advanced movement assistance corresponding to the position of the object in consideration of the position of the object present in the area in the blind spot as seen from the moving mobile object including the traveling vehicle 10.

With such a configuration, the movement assistance learning device 200 can provide the learned model enabling the movement assistance device 100 to perform the advanced movement assistance corresponding to the type of the object in consideration of the type of the object present in the area in the blind spot as seen from the moving mobile object including the traveling vehicle 10.

The movement assistance learning device 200 is configured so that, in the above-described configuration, the object acquiring unit 210 acquires the object information indicating the position and type of the object, and the learning unit 230 generates the learned model through learning of the object information as the training data.

With such a configuration, the movement assistance learning device 200 can provide the learned model enabling the movement assistance device 100 to perform the advanced movement assistance corresponding to the position and type of the object in consideration of the position and type of the object present in the area in the blind spot as seen from the moving mobile object including the traveling vehicle 10.

### Second Embodiment

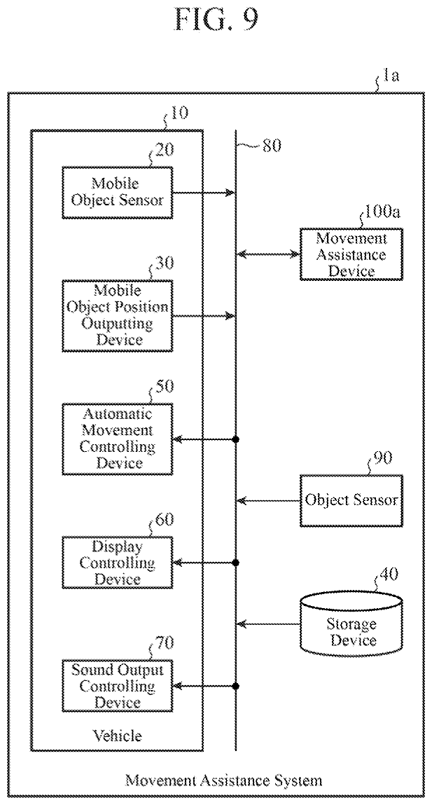

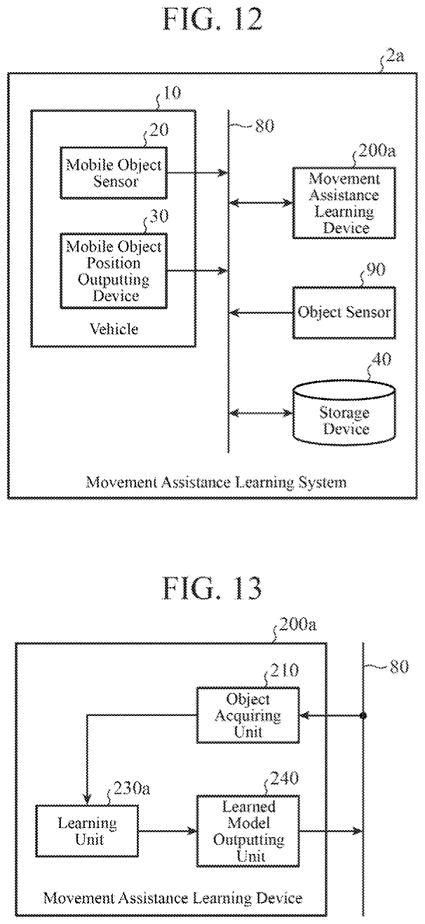

A movement assistance device 100a according to a second embodiment is described with reference to FIGS. 9 to 11. A movement assistance learning device 200a according to the second embodiment is described with reference to FIGS. 12 to 14.

As an example, the movement assistance device 100a and the movement assistance learning device 200a according to the second embodiment are applied to a vehicle 10 as a mobile object.

In the second embodiment, the mobile object is described as the vehicle 10, but the mobile object is not limited to the vehicle 10 as in the first embodiment. For example, the mobile object may be a pedestrian, a bicycle, a motorcycle, a mobile robot or the like as in the first embodiment.

FIG. 9 is a block diagram illustrating an example of a substantial part of a movement assistance system 1a to which the movement assistance device 100a according to the second embodiment is applied.

The movement assistance system 1a according to the second embodiment is provided with the movement assistance device 100a, the vehicle 10, a mobile object sensor 20, a mobile object position outputting device 30, a storage device 40, an automatic movement controlling device 50, a display controlling device 60, a sound output controlling device 70, a network 80, and an object sensor 90.

The movement assistance system 1a according to the second embodiment is different from the movement assistance system 1 according to the first embodiment in that the movement assistance device 100 is changed to the movement assistance device 100a.

In a configuration of the movement assistance system 1a according to the second embodiment, the configuration similar to that of the movement assistance system 1 according to the first embodiment is assigned with the same reference numeral, and redundant description thereof is omitted. That is, the description of the configuration in FIG. 9 assigned with the same reference numeral as that in FIG. 1 is omitted.

The movement assistance device 100a acquires movement assistance information and outputs the movement assistance information.

Specifically, the movement assistance device 100a acquires the movement assistance information output as an inference result by a learned model, and outputs the movement assistance information.

More specifically, the movement assistance device 100a inputs, to a learned model corresponding to a position of a blind spot object out of a plurality of learned models, blind spot object information indicating the position of the blind spot object, and acquires the movement assistance information output as the inference result by the learned model. Alternatively, the movement assistance device 100a inputs, to a learned model corresponding to a type of the blind spot object out of a plurality of learned models, blind spot object information indicating the type of the blind spot object, and acquires the movement assistance information output as the inference result by the learned model.

The learned model from which the movement assistance device 100a acquires the movement assistance information as the inference result is configured by, for example, a neural network.

The movement assistance device 100a may be installed in the vehicle 10 or may be installed in a predetermined place outside the vehicle 10. In the second embodiment, it is described on the premise that the movement assistance device 100a is installed in the predetermined place outside the vehicle 10.

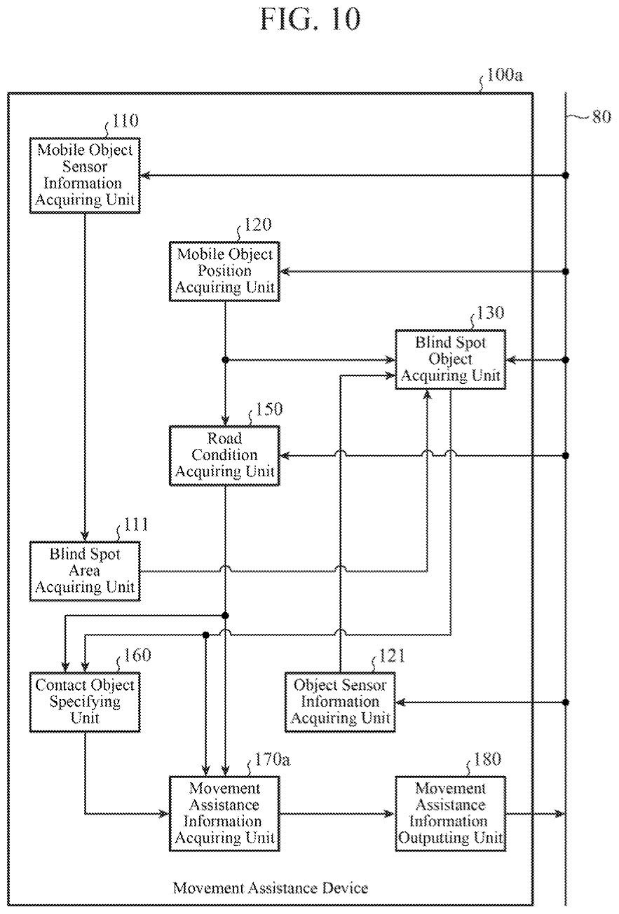

A configuration of a substantial part of the movement assistance device 100a according to the second embodiment is described with reference to FIG. 10.

FIG. 10 is a block diagram illustrating an example of the configuration of the substantial part of the movement assistance device 100a according to the second embodiment.

The movement assistance device 100a according to the second embodiment is provided with a mobile object sensor information acquiring unit 110, a blind spot area acquiring unit 111, a mobile object position acquiring unit 120, an object sensor information acquiring unit 121, a blind spot object acquiring unit 130, a road condition acquiring unit 150, a contact object specifying unit 160, a movement assistance information acquiring unit 170a, and a movement assistance information outputting unit 180.

The movement assistance device 100a according to the second embodiment is different from the movement assistance device 100 according to the first embodiment in that the movement assistance information acquiring unit 170 is changed to the movement assistance information acquiring unit 170a.

In a configuration of the movement assistance device 100a according to the second embodiment, the configuration similar to that of the movement assistance device 100 according to the first embodiment is assigned with the same reference numeral, and redundant description thereof is omitted. That is, the description of the configuration in FIG. 10 assigned with the same reference numeral as that in FIG. 2 is omitted.

The movement assistance information acquiring unit 170a acquires, on the basis of the blind spot object information corresponding to a specific blind spot object, which is an object specified by the contact object specifying unit 160, the movement assistance information for avoiding contact of the vehicle 10 with the specific blind spot object.

Specifically, the movement assistance information acquiring unit 170a inputs the blind spot object information corresponding to the specific blind spot object to the learned model, and acquires the movement assistance information output by the learned model as the inference result.

More specifically, the movement assistance information acquiring unit 170a inputs the blind spot object information corresponding to the specific blind spot object to the learned model corresponding to the position or type of the specific blind spot object indicated by the blind spot object information corresponding to the specific blind spot object out of a plurality of learned models, and acquires the movement assistance information output as the inference result by the learned model.

For example, the movement assistance information acquiring unit 170a first reads a plurality of learned models corresponding to learning results by machine learning stored in advance in the storage device 40 from the storage device 40 via the network 80, thereby acquiring the plurality of learned models.

The movement assistance information acquiring unit 170 according to the first embodiment acquires one learned model, whereas the movement assistance information acquiring unit 170a acquires a plurality of learned models. The movement assistance information acquiring unit 170a may include the plurality of learned models in advance.

Next, the movement assistance information acquiring unit 170a selects the learned model corresponding to the position or type indicated by the blind spot object information corresponding to the specific blind spot object out of the plurality of learned models acquired by the movement assistance information acquiring unit 170a.

That is, each of the plurality of learned models is the learned model corresponding to each position or each type of the object.

The learned model corresponding to each position of the object is, for example, the learned model corresponding to each of a plurality of distance ranges determined in advance in a distance from the vehicle 10 in a direction in which the vehicle 10 as the mobile object travels or a distance from a route on which the vehicle 10 is scheduled to travel. A plurality of distance ranges includes ranges shorter than 5 meters (m), equal to or longer than 5 m and shorter than 15 m, equal to or longer than 15 m and shorter than 30 m, and equal to or longer than 30 m. The above-described distance range is merely an example, and it is not limited thereto.

In a case where the blind spot object information is the information indicating the position of the blind spot object, for example, the movement assistance information acquiring unit 170a selects the learned model corresponding to the distance range in which the position indicated by the blind spot object information corresponding to the specific blind spot object is included out of the plurality of learned models acquired by the movement assistance information acquiring unit 170a.

The learned model corresponding to each type of the object is, for example, the learned model corresponding to each of a plurality of type groups of the objects determined in advance. The plurality of type groups include a power mobile object group such as an automobile or a motorcycle that travels by power such as an engine, a motor or the like, a human mobile object group such as a bicycle or a pedestrian that moves by human power, a stationary object group such as an installation or a structure and the like. The above-described type group is merely an example, and it is not limited thereto.

In a case where the blind spot object information is the information indicating the type of the blind spot object, for example, the movement assistance information acquiring unit 170a selects the learned model corresponding to the type group in which the type indicated by the blind spot object information corresponding to the specific blind spot object is included out of the plurality of learned models acquired by the movement assistance information acquiring unit 170a.

Next, the movement assistance information acquiring unit 170a inputs the blind spot object information corresponding to the specific blind spot object to the learned model.

Next, the movement assistance information acquiring unit 170a acquires the movement assistance information by acquiring the movement assistance information output as the inference result by the learned model.

The movement assistance information acquired by the movement assistance information acquiring unit 170a acquiring the movement assistance information output as the inference result by the learned model is the movement assistance information corresponding to the position or type of the specific blind spot object.

With such a configuration, the movement assistance device 100a can acquire the movement assistance information depending on the position or type of the specific blind spot object.

In a case where the blind spot object acquiring unit 130 acquires the blind spot object information indicating the position and type of each of one or more blind spot objects, the movement assistance information acquiring unit 170a may select the learned model corresponding to the position and type indicated by the blind spot object information corresponding to the specific blind spot object even when the learned model corresponding to the position or type indicated by the blind spot object information corresponding to the specific blind spot object is selected out of the plurality of learned models acquired by the movement assistance information acquiring unit 170a.

The learned model corresponding to the position and type of the object is, for example, the learned model corresponding to each of a plurality of distance ranges determined in advance and corresponding to each of a plurality of type groups of the objects determined in advance.

With such a configuration, the movement assistance device 100a can acquire the movement assistance information depending on the position and type of the specific blind spot object.

In a case where the movement assistance device 100a is provided with the road condition acquiring unit 150, the movement assistance information acquiring unit 170a may input road condition information acquired by the road condition acquiring unit 150 to the learned model in addition to the blind spot object information corresponding to the specific blind spot object, and acquire the movement assistance information output as the inference result by the learned model.

With such a configuration, the movement assistance device 100a can acquire the movement assistance information depending on not only the position or type of the specific blind spot object but also the condition of the road on which the vehicle 10 travels.

Note that, each function of the mobile object sensor information acquiring unit 110, the blind spot area acquiring unit 111, the mobile object position acquiring unit 120, the object sensor information acquiring unit 121, the blind spot object acquiring unit 130, the road condition acquiring unit 150, the contact object specifying unit 160, the movement assistance information acquiring unit 170a, and the movement assistance information outputting unit 180 provided on the movement assistance device 100a may be implemented by a processor 401 and the memory 402 or may be implemented by a processing circuit 403 in the hardware configuration an example of which is illustrated in FIGS. 4A and 4B.

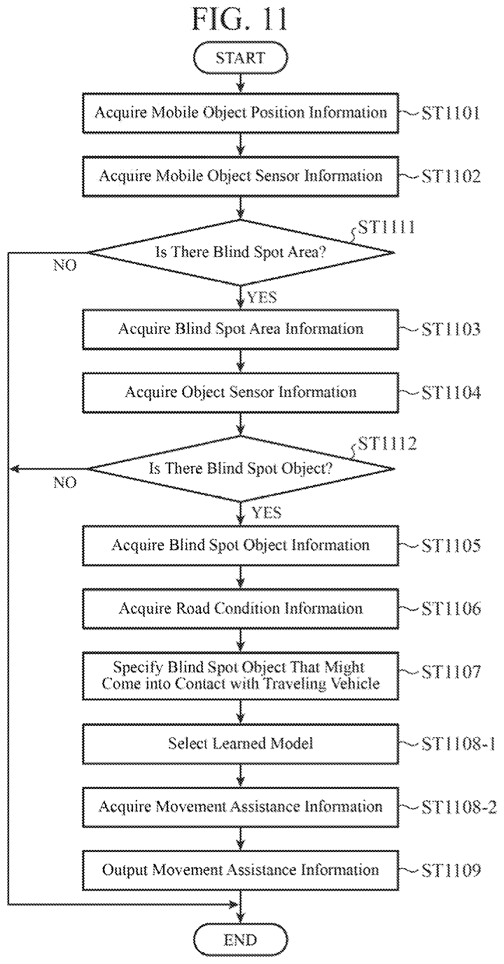

An operation of the movement assistance device 100a according to the second embodiment is described with reference to FIG. 11.

FIG. 11 is a flowchart illustrating an example of processing of the movement assistance device 100a according to the first embodiment.

The movement assistance device 100a repeatedly executes the flowchart while the vehicle 10 is traveling.

First, at step ST1101, the mobile object position acquiring unit 120 acquires mobile object position information.

Next, at step ST1102, the mobile object sensor information acquiring unit 110 acquires mobile object sensor information.

Next, at step ST1111, the blind spot area acquiring unit 111 determines whether or not there is a blind spot area.

At step ST1111, in a case where the blind spot area acquiring unit 111 determines that there is no blind spot area, the movement assistance device 100a finishes the processing of the flowchart. After finishing the processing of the flowchart, the movement assistance device 100a returns to the processing at step ST1101 and repeatedly executes the processing of the flowchart.

At step ST1111, in a case where the blind spot area acquiring unit 111 determines that there is the blind spot area, the blind spot area acquiring unit 111 acquires blind spot area information at step ST1103.

After step ST1103, at step ST1104, the object sensor information acquiring unit 121 acquires object sensor information.

After step ST1104, at step ST1112, the blind spot object acquiring unit 130 determines whether or not there is the blind spot object.

At step ST1112, in a case where the blind spot object acquiring unit 130 determines that there is no blind spot object, the movement assistance device 100a finishes the processing of the flowchart. After finishing the processing of the flowchart, the movement assistance device 100a returns to the processing at step ST1101 and repeatedly executes the processing of the flowchart.

At step ST1112, in a case where the blind spot object acquiring unit 130 determines that there is the blind spot object, the blind spot object acquiring unit 130 acquires the blind spot object information at step ST1105.

After step ST1105, at step ST1106, the road condition acquiring unit 150 acquires the road condition information.

After step ST1106, at step ST1107, the contact object specifying unit 160 specifies the blind spot object with which the vehicle 10 that travels might come into contact out of the one or more blind spot objects.

Next, after step ST1107, at step ST1108-1, the movement assistance information acquiring unit 170a selects the learned model.

After step ST1108-1, at step ST1108-2, the movement assistance information acquiring unit 170a acquires the movement assistance information.

After step ST1108-2, at step ST1109, the movement assistance information outputting unit 180 outputs the movement assistance information.

After the processing at step ST1109, the movement assistance device 100a finishes the processing of the flowchart. After finishing the processing of the flowchart, the movement assistance device 100a returns to the processing at step ST1101 and repeatedly executes the processing of the flowchart.

Note that, the processing at step ST1101 may be performed at any timing before the processing at step ST1105 is performed.

The processing at step ST1104 may be performed at any timing before the processing at step ST1105 is performed.

The processing at step ST1106 may be performed at any timing before the processing at step ST1107 or step ST1108-2 is performed.

In a case where the movement assistance device 100a is not provided with the object sensor information acquiring unit 121, the processing at step ST1104 is omitted.

In a case where the movement assistance device 100a is not provided with the road condition acquiring unit 150, the processing at step ST1106 is omitted.

The learned model used when the movement assistance information acquiring unit 170a acquires the movement assistance information is generated by the movement assistance learning device 200a, for example.

The movement assistance learning device 200a according to the second embodiment is described with reference to FIGS. 12 to 14.

FIG. 12 is a block diagram illustrating an example of a substantial part of a movement assistance learning system 2a to which the movement assistance learning device 200a according to the second embodiment is applied.

The movement assistance learning system 2a according to the second embodiment is provided with the movement assistance learning device 200a, the vehicle 10, the mobile object sensor 20, the mobile object position outputting device 30, the storage device 40, the network 80, and the object sensor 90.

In a configuration of the movement assistance learning system 2a according to the second embodiment, the configuration similar to that of the movement assistance learning system 2 according to the first embodiment is assigned with the same reference numeral, and redundant description thereof is omitted. That is, the description of the configuration in FIG. 12 assigned with the same reference numeral as that in FIG. 6 is omitted.

The movement assistance learning device 200a generates a plurality of learned models capable of outputting the movement assistance information for avoiding the contact of the vehicle 10 as the mobile object with an object.

More specifically, the movement assistance learning device 200a generates the learned model corresponding to each of a plurality of positions or each of a plurality of types.

The movement assistance learning device 200a generates the learned model by changing a parameter of a learning model formed of a neural network prepared in advance, for example, by allowing the same to learn by deep learning.

The movement assistance learning device 200a may be installed in the vehicle 10 or may be installed in a predetermined place outside the vehicle 10. In the second embodiment, it is described on the premise that the movement assistance learning device 200a is installed in the predetermined place outside the vehicle 10.

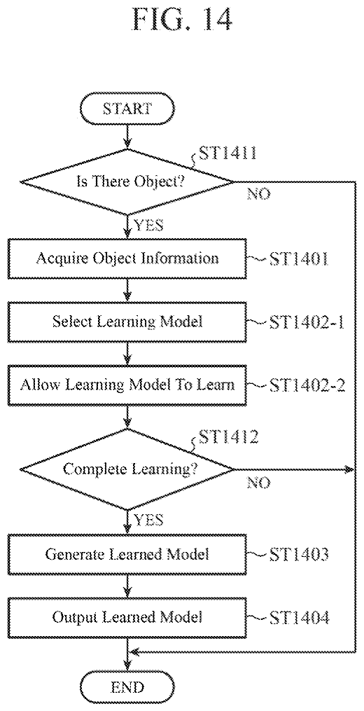

A configuration of a substantial part of the movement assistance learning device 200a according to the second embodiment is described with reference to FIG. 13.

FIG. 13 is a block diagram illustrating an example of the configuration of the substantial part of the movement assistance learning device 200a according to the second embodiment.

The movement assistance learning device 200a according to the second embodiment is provided with an object acquiring unit 210, a learning unit 230a, and a learned model outputting unit 240.

The movement assistance learning device 200a according to the second embodiment is different from the movement assistance learning device 200 according to the first embodiment in that the learning unit 230 is changed to the learning unit 230a.

In a configuration of the movement assistance learning device 200a according to the second embodiment, the configuration similar to that of the movement assistance learning device 200 according to the first embodiment is assigned with the same reference numeral, and redundant description thereof is omitted. That is, the description of the configuration in FIG. 13 assigned with the same reference numeral as that in FIG. 7 is omitted.

The learning unit 230a generates, on the basis of the object information acquired by the object acquiring unit 210, the learned model capable of outputting the movement assistance information for avoiding the contact of the vehicle 10 as the mobile object with the object.

Specifically, for example, the learning unit 230a generates each learned model through learning of the object information as training data.

More specifically, for example, the learning unit 230a selects the learning model allowed to learn out of a plurality of learning models prepared in advance for each distance range or each type group on the basis of the position or type of the object indicated by the object information. The learning unit 230a changes, by allowing the selected learning model to learn the object information as the training data, the parameter of the learning model. The learning unit 230a generates the learned model corresponding to each of a plurality of distance ranges or the learned model corresponding to each of a plurality of type groups by allowing all the learning models to repeatedly learn.

For example, in a case where the object information is the information indicating the position of the object, the learning unit 230a selects the learning model corresponding to the distance range including the position of the object indicated by the object information, and allows the selected learning model to learn the object information as the training data.

For example, in a case where the object information is the information indicating the type of the object, the learning unit 230a selects the learning model corresponding to the type group including the type of the object indicated by the object information, and allows the selected learning model to learn the object information as the training data.

With such a configuration, the movement assistance learning device 200a can generate the learned model corresponding to each of a plurality of distance ranges or the learned model corresponding to each of a plurality of type groups.

In a case where the object information is the information indicating the position and type of the object, the learning unit 230a may select, when selecting the learning model allowed to learn the object information as the training data, the learning model corresponding to the distance range including the position of the object indicated by the object information or the learning model corresponding to the type group including the type of the object indicated by the object information, or may select the learning model corresponding to the distance range including the position of the object indicated by the object information and corresponding to the type group including the type of the object indicated by the object information.

The learned model outputting unit 240 outputs a plurality of learned models generated by the learning unit 230a.

Specifically, for example, the learned model outputting unit 240 outputs the plurality of learned models generated by the learning unit 230a to the storage device 40 via the network 80 and stores the same in the storage device 40.

Note that, the learning unit 230a described so far generates the learned model through learning of the object information indicating the position or type of the object present in the predetermined area around the vehicle 10 as the training data.

The learning unit 230a may also generate the learned model through learning of the object information indicating the moving speed, the moving direction, the acceleration or the like of the object in addition to the position of the object present in the predetermined area around the vehicle 10 as the training data.

The learning unit 230a can generate the learned model capable of performing the movement assistance with higher accuracy when the learning unit 230a allows learning of the object information indicating the moving speed, the moving direction, the acceleration or the like of the object in addition to the position of the object present in the predetermined area around the vehicle 10 as the training data.

In a case where the movement assistance learning device 200a generates the learned model through learning of the object information indicating the moving speed, the moving direction, the acceleration or the like of the object in addition to the position of the object present in the predetermined area around the vehicle 10 as the training data, for example, the movement assistance device 100a inputs the blind spot object information indicating the moving speed, the moving direction, the acceleration or the like of the blind spot object in addition to the position of the blind spot object to the learned model and acquires the movement assistance information output by the learned model as the inference result.

With such a configuration, the movement assistance device 100a can acquire the movement assistance information for performing the movement assistance with higher accuracy.

The learning unit 230a described so far generates the learned model through learning of the object information indicating the position or type of the object as the training data regarding the object present in the predetermined area around the vehicle 10 regardless of whether or not this is the object present in the blind spot area of the mobile object sensor 20 provided on the vehicle 10.

The learning unit 230a may also generate the learned model through learning of the object information indicating the position or type of the blind spot object as the training data regarding the object present in the blind spot area of the mobile object sensor 20 provided on the vehicle 10, that is, the blind spot object.

The learning unit 230a allows learning of the object information indicating the position or type of the blind spot object as the training data, so that the learning unit 230a can generate the learned model capable of performing the movement assistance with higher accuracy.

In a case where the movement assistance learning device 200a generates the learned model through learning of the object information indicating the position or type of the blind spot object as the training data, the object acquiring unit 210 provided on the movement assistance learning device 200a has a function equivalent to that of the blind spot object acquiring unit 130 provided on the movement assistance device 100a, for example.

In this case, the movement assistance learning device 200a includes, for example, a means having functions of the mobile object sensor information acquiring unit 110, the blind spot area acquiring unit 111, the object sensor information acquiring unit 121, and the contact object specifying unit 160 provided on the movement assistance device 100a.

The movement assistance learning device 200a generates the learned model through learning of the object information indicating the position or type of the blind spot object as the training data, so that the movement assistance device 100a can acquire the movement assistance information for performing the movement assistance with higher accuracy.

The movement assistance learning device 200a is provided with a means for acquiring the road condition information indicating the condition of the road on which the vehicle 10 travels such as the road width, the number of lanes, the road type, and the presence or absence of the sidewalk of the road on which the vehicle 10 travels, or the connection point and the connection state between the road and a road connected to the road, and the learning unit 230a may generate the learned model through learning of the road condition information as the training data in addition to the object information.

In a case where the movement assistance learning device 200a generates the learned model through learning of the object information and the road condition information as the training data, for example, the movement assistance device 100a inputs the blind spot object information and the road condition information to the learned model and acquires the movement assistance information output by the learned model as the inference result.

With such a configuration, the movement assistance device 100a can acquire the movement assistance information for performing the movement assistance with higher accuracy.

Since the learning method by which the learning unit 230a allows each of the plurality of learning models to learn is similar to the learning method by which the learning unit 230 according to the first embodiment allows the learning model to learn, the description thereof is omitted.

Each function of the object acquiring unit 210, the learning unit 230a, and the learned model outputting unit 240 provided on the movement assistance learning device 200a may be implemented by the processor 401 and the memory 402 or may be implemented by the processing circuit 403 in the hardware configuration an example of which is illustrated in FIGS. 4A and 4B as in the hardware configuration of the movement assistance device 100a.

An operation of the movement assistance learning device 200a according to the second embodiment is described with reference to FIG. 14.

FIG. 14 is a flowchart illustrating an example of processing of the movement assistance learning device 200a according to the second embodiment.

The movement assistance learning device 200a generates a plurality of learned models by repeatedly executing the flowchart while the vehicle 10 is traveling until all of the plurality of learned model is generated.

First, at step ST1411, the object acquiring unit 210 determines whether or not there is an object in the predetermined area around the vehicle 10.

At step ST1411, in a case where the object acquiring unit 210 determines that there is no object in the predetermined area around the vehicle 10, the movement assistance learning device 200a repeatedly executes the processing at step ST1411 until the object acquiring unit 210 determines that there is an object in the predetermined area around the vehicle 10.

At step ST1411, in a case where the object acquiring unit 210 determines that there is the object in the predetermined area around the vehicle 10, the object acquiring unit 210 acquires the object information at step ST1401.

Next, at step ST1402-1, the learning unit 230a selects the learning model allowed to learn on the basis of the position or type of the object indicated by the object information.

Next, at step ST1402-2, the learning unit 230a allows the selected learning model to learn, thereby changing a parameter of the learning model.

Next, at step ST 1412, the learning unit 230a determines whether or not the learning of all the learning models is completed. Specifically, for example, the learning unit 230a determines whether or not learning of all the learning models is completed by determining whether or not all the learning models are allowed to learn the predetermined number of learnings. For example, the learning unit 230a determines whether or not the learning of all the learning models is completed by determining whether or not a user performs an operation indicating completion of learning via an input device not illustrated.

At step ST1412, in a case where the learning unit 230a determines that the learning of all the learning models is not completed, the movement assistance learning device 200a finishes the processing of the flowchart. After finishing the processing of the flowchart, the movement assistance learning device 200a returns to the processing at step ST1411 and repeatedly executes the processing of the flowchart.

At step ST1412, in a case where the learning unit 230a determines that the learning of all the learning models is completed, at step ST1403, the learning unit 230a generates the learned model by making the learning model the learned model.

After the processing at step ST1403, at step ST1404, the learned model outputting unit 240 outputs the learned model.

After the processing at step ST1404, the movement assistance learning device 200a finishes the processing of the flowchart.

As described above, the movement assistance device 100a is provided with the mobile object sensor information acquiring unit 110 that acquires the mobile object sensor information output by the mobile object sensor 20, which is the sensor provided on the mobile object; the blind spot area acquiring unit 111 that acquires the blind spot area information indicating the blind spot area of the mobile object sensor 20 on the basis of the mobile object sensor information acquired by the mobile object sensor information acquiring unit 110; the blind spot object acquiring unit 130 that acquires the blind spot object information indicating the position or type of each of the one or more objects present in the blind spot area indicated by the blind spot area information acquired by the blind spot area acquiring unit 111; the contact object specifying unit 160 that specifies an object with which the mobile object might come into contact when the mobile object moves out of the one or more objects present in the blind spot area on the basis of the blind spot object information acquired by the blind spot object acquiring unit 130; the movement assistance information acquiring unit 170a that inputs the blind spot object information corresponding to the object specified by the contact object specifying unit 160 to the learned model and acquires the information output by the learned model as the inference result, the information for avoiding the contact of the mobile object with the object; and the movement assistance information outputting unit 180 that outputs the movement assistance information acquired by the movement assistance information acquiring unit 170a, in which the movement assistance information acquiring unit 170a inputs the blind spot object information corresponding to the object to the learned model corresponding to the position or type of the object indicated by the blind spot object information corresponding to the object specified by the contact object specifying unit 160 out of a plurality of learned models and acquires the movement assistance information output by the learned model as the inference result.

With such a configuration, the movement assistance device 100a can perform advanced movement assistance in consideration of a condition of the area in the blind spot as seen from the moving mobile object including the traveling vehicle 10.

With such a configuration, the movement assistance device 100a can perform the advanced movement assistance corresponding to the type of the object in consideration of the position of the object present in the area in the blind spot as seen from the moving mobile object including the traveling vehicle 10.

With such a configuration, the movement assistance device 100a can perform the advanced movement assistance corresponding to the type of the object in consideration of the type of the object present in the area in the blind spot as seen from the moving mobile object including the traveling vehicle 10.

With such a configuration, the movement assistance device 100a can perform the advanced movement assistance corresponding to the position, the moving direction, the moving speed, the acceleration or the like of the object in consideration of the moving direction, the moving speed, the acceleration or the like of the object in addition to the position of the object present in the area in the blind spot as seen from the moving mobile object including the traveling vehicle 10.

In the above-described configuration, the movement assistance device 100a is configured so that the blind spot object acquiring unit 130 acquires the blind spot object information indicating the position and type of each of the one or more objects present in the blind spot area indicated by the blind spot area information acquired by the blind spot area acquiring unit 111, the contact object specifying unit 160 specifies an object with which the mobile object might come into contact when the mobile object moves out of the one or more objects present in the blind spot area on the basis of the position or type of each of the one or more objects present in the blind spot area indicated by the blind spot object information acquired by the blind spot object acquiring unit 130, and the movement assistance information acquiring unit 170a inputs the blind spot object information corresponding to the object to the learned model corresponding to the position or type indicated by the blind spot object information corresponding to the object specified by the contact object specifying unit 160 or the learned model corresponding to the position and type indicated by the blind spot object information corresponding to the object specified by the contact object specifying unit 160, and acquires the movement assistance information output by the learned model as the inference result.

With such a configuration, the movement assistance device 100a can perform the advanced movement assistance corresponding to the position and type of the object in consideration of the position and type of the object present in the area in the blind spot as seen from the moving mobile object including the traveling vehicle 10.

The movement assistance device 100a is provided with, in addition to the above-described configuration, the road condition acquiring unit 150 that acquires the road condition information indicating the condition of the road on which the vehicle 10 travels, and the contact object specifying unit 160 is configured to specify an object with which the mobile object might come into contact when the mobile object moves out of the one or more objects present in the blind spot area on the basis of the road condition information acquired by the road condition acquiring unit 150 in addition to the blind spot object information.

With such a configuration, the movement assistance device 100a can specify the object with which the mobile object might come into contact with high accuracy out of the one or more objects present in the area in the blind spot as seen from the moving mobile object including the traveling vehicle 10, so that this can perform the advanced movement assistance corresponding to the position or type of the object with high accuracy in consideration of the position or type of the mobile object.

The movement assistance device 100a is provided with, in addition to the above-described configuration, the road condition acquiring unit 150 that acquires the road condition information indicating the condition of the road on which the vehicle 10 travels, and the movement assistance information acquiring unit 170a is configured to input the road condition information acquired by the road condition acquiring unit 150 to the learned model corresponding to the position or type indicated by the blind spot object information corresponding to the object in addition to the blind spot object information corresponding to the object specified by the contact object specifying unit 160 and acquire the movement assistance information output as the inference result by the learned model.

With such a configuration, the movement assistance device 100a can perform the advanced movement assistance corresponding to the position or type of the object and the condition of the road on which the vehicle 10 travels in consideration of the condition of the road on which the vehicle 10 travels in addition to the position or type of the object present in the area in the blind spot as seen from the moving mobile object including the traveling vehicle 10.

In addition to the above-described configuration, the movement assistance device 100a is provided with the object sensor information acquiring unit 121 that acquires the object sensor information output by the object sensor 90, which is a sensor provided on an object other than the vehicle 10, and the blind spot object acquiring unit 130 is configured to acquire the blind spot object information indicating the position or type of each of the one or more objects present in the blind spot area indicated by the blind spot area information on the basis of the object sensor information acquired by the object sensor information acquiring unit 121.

With such a configuration, the movement assistance device 100a can acquire the position and type of the one or more objects present in the blind spot area even in a case where the information indicating the position or type of the one or more objects present in the area in the blind spot as seen from the moving mobile object including the traveling vehicle 10 is not prepared in advance, so that this can perform the advanced movement assistance corresponding to the type of the object in consideration of the type of the object present in the area in the blind spot as seen from the moving mobile object including the traveling vehicle 10.

As described above, the movement assistance learning device 200a is provided with the object acquiring unit 210 that acquires the object information indicating the position or type of the object, and the learning unit 230a that generates the learned model capable of outputting the movement assistance information for avoiding the contact of the mobile object with the object through learning of the object information acquired by the object acquiring unit 210 as the training data, and the learning unit 230a is configured to generate a plurality of learned models corresponding to each of a plurality of positions or each of a plurality of types, and to generate the learned model corresponding to the position or type indicated by the object information through learning of the object information as the training data.

With such a configuration, the movement assistance learning device 200a can provide the learned model enabling the movement assistance device 100a to perform the advanced movement assistance in consideration of the condition of the area in the blind spot as seen from the moving mobile object including the traveling vehicle 10.

With such a configuration, the movement assistance learning device 200a can provide the learned model enabling the movement assistance device 100a to perform the advanced movement assistance corresponding to the position of the object in consideration of the position of the object present in the area in the blind spot as seen from the moving mobile object including the traveling vehicle 10.

With such a configuration, the movement assistance learning device 200a can provide the learned model enabling the movement assistance device 100a to perform the advanced movement assistance corresponding to the type of the object in consideration of the type of the object present in the area in the blind spot as seen from the moving mobile object including the traveling vehicle 10.

The movement assistance learning device 200a is configured so that, in the above-described configuration, the object acquiring unit 210 acquires the object information indicating the position and type of the object, and the learning unit 230a generates a plurality of learned models through learning of the object information as the training data.

With such a configuration, the movement assistance learning device 200a can provide the learned model enabling the movement assistance device 100a to perform the advanced movement assistance corresponding to the position and type of the object in consideration of the position and type of the object present in the area in the blind spot as seen from the moving mobile object including the traveling vehicle 10.

Note that, in the movement assistance system 1 and the movement assistance learning system 2 according to the first embodiment, the movement assistance device 100 and the movement assistance learning device 200 are described as different devices, but it is not limited thereto. For example, the movement assistance device 100 may be provided with each unit provided on the movement assistance learning device 200, and the movement assistance device 100 provided with each unit provided on the movement assistance learning device 200 may generate the learned model while the vehicle 10 is traveling, that is, while the mobile object is moving.

Similarly, in the movement assistance system 1a and the movement assistance learning system 2a according to the second embodiment, the movement assistance device 100a and the movement assistance learning device 200a are described as different devices, but it is not limited thereto. The movement assistance device 100a may be provided with each unit provided on the movement assistance learning device 200a, and the movement assistance device 100a provided with each unit provided on the movement assistance learning device 200a may generate the learned model while the vehicle 10 is traveling, that is, while the mobile object is moving.

In the present invention, the embodiments may be freely combined, any component of each embodiment may be modified, or any component may be omitted in each embodiment without departing from the scope of the invention.

### INDUSTRIAL APPLICABILITY

The movement assistance device according to the present invention can be applied to a movement assistance system and the like. The movement assistance learning device according to the present invention can be applied to a movement assistance learning system, a movement assistance device or the like.

### REFERENCE SIGNS LIST

1, 1a: movement assistance system, 10: vehicle, 20: mobile object sensor, 30: mobile object position outputting device, 40: storage device, 50: automatic movement controlling device, 60: display controlling device, 70: sound output controlling device, 80: network, 90: object sensor, 100, 100a: movement assistance device, 110: mobile object sensor information acquiring unit, 111: blind spot area acquiring unit, 120: mobile object position acquiring unit, 121: object sensor information acquiring unit, 130: blind spot object acquiring unit, 150: road condition acquiring unit, 160: contact object specifying unit, 170, 170a: movement assistance information acquiring unit, 180: movement assistance information outputting unit, 2, 2a: movement assistance learning system, 200, 200a: movement assistance learning device, 210: object acquiring unit, 230, 230a: learning unit, 240: learned model outputting unit, 401: processor, 402: memory, 403: processing circuit

1. A movement assistance device comprising:
processing circuitry to perform a process to:
acquire mobile object sensor information output by a mobile object sensor, which is a sensor provided on a mobile object;
acquire blind spot area information indicating a blind spot area of the mobile object sensor on a basis of the mobile object sensor information acquired;
acquire blind spot object information indicating a position or a type of each of one or more objects present in the blind spot area indicated by the blind spot area information acquired;
specify the object with which the mobile object might come into contact when the mobile object moves out of the one or more objects present in the blind spot area on a basis of the blind spot object information acquired;
input the blind spot object information corresponding to the object specified to a learned model and acquire movement assistance information, which is information output by the learned model as an inference result, the information for avoiding contact of the mobile object with the object; and
output the movement assistance information acquired.

2. The movement assistance device according to claim 1, wherein
the process acquires the blind spot object information indicating the position and the type of each of the one or more objects present in the blind spot area indicated by the blind spot area information acquired,
the process specifies the object with which the mobile object might come into contact when the mobile object moves out of the one or more objects present in the blind spot area on a basis of the position or the type of each of the one or more objects present in the blind spot area indicated by the blind spot object information acquired, and
the process inputs the blind spot object information corresponding to the object specified to the learned model and acquires the movement assistance information output as the inference result by the learned model.

3. The movement assistance device according to claim 1, the process comprising:
to acquire road condition information indicating a condition of a road on which the mobile object moves, wherein
the process specifies the object with which the mobile object might come into contact when the mobile object moves out of the one or more objects present in the blind spot area on a basis of the road condition information acquired in addition to the blind spot object information.

4. The movement assistance device according to claim 1, the process comprising:
to acquire road condition information indicating a condition of a road on which the mobile object moves, wherein
the process inputs the road condition information acquired to the learned model in addition to the blind spot object information corresponding to the object specified and acquires the movement assistance information output as the inference result by the learned model.

5. The movement assistance device according to claim 1, the process comprising:
to acquire object sensor information output by an object sensor, which is a sensor provided on an object other than the mobile object, wherein
the process acquires the blind spot object information indicating the position or the type of each of the one or more objects present in the blind spot area indicated by the blind spot area information on a basis of the object sensor information acquired.

6. The movement assistance device according to claim 1, wherein
the process inputs, to the learned model corresponding to a position or a type of a blind spot object indicated by the blind spot object information corresponding to the object specified out of a plurality of learned models, the blind spot object information corresponding to the object and acquires the movement assistance information output as the inference result by the learned model.

7. A movement assistance learning device comprising:
processing circuitry to perform a process to:
acquire object information indicating a position or a type of an object; and
generate a learned model capable of outputting movement assistance information for avoiding contact of a mobile object with the object through learning of the object information acquired as training data.

8. The movement assistance learning device according to claim 7, wherein
the process acquires the object information indicating the position and the type of the object, and
the process generates the learned model through learning of the object information as the training data.

9. The movement assistance learning device according to claim 7, wherein
the process generates a plurality of learned models corresponding to each of a plurality of positions or each of a plurality of types, and generates the learned model corresponding to the position or the type indicated by the object information through learning of the object information as the training data.

10. A movement assistance method comprising:
acquiring mobile object sensor information output by a mobile object sensor, which is a sensor provided on a mobile object;
acquiring blind spot area information indicating a blind spot area of the mobile object sensor on a basis of the mobile object sensor information acquired;
acquiring blind spot object information indicating a position or a type of each of one or more objects present in the blind spot area indicated by the blind spot area information acquired;
specifying the object with which the mobile object might come into contact when the mobile object moves out of the one or more objects present in the blind spot area on a basis of the blind spot object information acquired;
inputting the blind spot object information corresponding to the object specified to a learned model and acquire movement assistance information, which is information output by the learned model as an inference result, the information for avoiding contact of the mobile object with the object; and
outputting the movement assistance information acquired.
